(19) United States
(12) Patent Application Publication
(10) Pub. No.: US 2026/0291104 A1
(43) Pub. Date: Sep. 24, 2026

(54) FEMALE TERMINAL AND CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke YAMADA, Mie (JP); Seido NISHIJIMA, Mie (JP); Katsuhiko AIZAWA, Mie (JP); Tomohiro HAYASHI, Mie (JP); Takato MIZUNO, Mie (JP)

(21) Appl. No.: 19/490,947

(22) PCT Filed: May 21, 2024
(86) PCT No.: PCT/JP2024/018578

§ 371 Date: Dec. 8, 2025

(30) Foreign Application Priority Data
Jun. 9, 2023 (JP) 2023-095639
Dec. 5, 2023 (JP) 2023-205257

(51) Int. Cl. H01R 13/11

(52) U.S. Cl. CPC H01R 13/111

(57) ABSTRACT

A female terminal includes a first peripheral wall having a first tubular portion, a second peripheral wall having a second tubular portion facing the first tubular portion, and a tubular connecting portion composed of the first tubular portion and the second tubular portion. The female terminal includes a winding/pressing portion for limiting a separation distance between a first inner surface of the first tubular portion and a second inner surface of the second tubular portion. The tubular connecting portion is a first connecting portion, into which a columnar connecting portion of a male terminal is inserted and which is electrically connected to the columnar connecting portion. The winding/pressing portion is integrally formed to the first peripheral wall.

### TECHNICAL FIELD

The present disclosure relates to a female terminal and a connector.

### BACKGROUND

Conventionally, a connector provided with a housing and a female terminal held in the housing has been known as a connector to be installed in a vehicle. A columnar connecting portion of a male terminal is inserted into and electrically connected to a tubular connecting portion of the female terminal. The female terminal of this type stably ensures a contact pressure with the columnar connecting portion of the male terminal, utilizing a biasing force by a biasing member such as a coil spring (see, for example, Patent Document 1).

### PRIOR ART DOCUMENT

### Patent Document

Patent Document 1: JP 2021-028903 A

### SUMMARY OF THE INVENTION

### Problems to Be Solved

In the above connector, it is desired to simplify the structure of the female terminal.

The present disclosure aims to provide a female terminal and a connector capable of simplifying structures.

### Means to Solve the Problem

The present disclosure is directed to a female terminal with a first peripheral wall having a first tubular portion, a second peripheral wall having a second tubular portion facing the first tubular portion, a tubular connecting portion composed of the first tubular portion and the second tubular portion, and a winding/pressing portion for limiting a separation distance between a first inner surface of the first tubular portion and a second inner surface of the second tubular portion, the tubular connecting portion being a first connecting portion, a columnar connecting portion of a male terminal being inserted into the first connecting portion, the first connecting portion being electrically connected to the columnar connecting portion, the winding/pressing portion being integrally formed to the first peripheral wall, and the winding/pressing portion being folded from the first peripheral wall toward the second peripheral wall, the winding/pressing portion being held in contact with an outer surface of the second peripheral wall.

### Effect of the Invention

According to the female terminal and a connector of the present disclosure, an effect of being able to simplify structures is achieved.

### BRIEF DESCRIPTION OF THE DRAWINGS

FIG. 1 is a perspective view showing a wiring harness of a first embodiment.

FIG. 2 is an exploded perspective view showing the wiring harness of the first embodiment.

FIG. 3 is an exploded perspective view showing the wiring harness of the first embodiment.

FIG. 4 is a perspective view showing a part of the wiring harness of the first embodiment.

FIG. 5 is a plan view showing the part of the wiring harness of the first embodiment.

FIG. 6 is a plan view showing the part of the wiring harness of the first embodiment.

FIG. 7 is a section showing a part of the wiring harness of the first embodiment (section along 7-7 in FIGS. 5 and 6).

FIG. 8 is a section showing a part of the wiring harness of the first embodiment (section along 8-8 in FIGS. 5 and 6).

FIG. 9 is a section showing a female terminal of the first embodiment (section along 9-9 in FIGS. 5 and 6).

FIG. 10 is a section showing the female terminal of the first embodiment (section along 10-10 in FIG. 9).

FIG. 11 is a perspective view in section showing the female terminal of the first embodiment.

FIG. 12 is an exploded perspective view showing a part of the wiring harness of the first embodiment.

FIG. 13 is a plan view showing a part of the wiring harness of the first embodiment.

FIG. 14 is a section showing a part of the wiring harness of the first embodiment (section along 14-14 in FIG. 13).

FIG. 15 is a perspective view showing a female terminal of a second embodiment.

FIG. 16 is a plan view showing the female terminal of the second embodiment.

FIG. 17 is a perspective view showing the female terminal of the second embodiment.

FIG. 18 is a perspective view showing the female terminals of the second embodiment being manufactured.

FIG. 19 is a perspective view showing a female terminal of a third embodiment.

FIG. 20 is a plan view showing a part of a wiring harness of the third embodiment.

FIG. 21 is a section showing a part of the wiring harness of the third embodiment (section along 21A-21A in FIG. 20).

FIG. 22 is a section showing a part of the wiring harness of the third embodiment (section along 22A-22A in FIG. 20).

FIG. 23 is a plan view showing the female terminal of the third embodiment.

### Detailed Description to Execute the Invention

### Description of Embodiments of Present Disclosure

First, embodiments of the present disclosure are listed and described.

[1] The female terminal of the present disclosure is provided with a first peripheral wall having a first tubular portion, a second peripheral wall having a second tubular portion facing the first tubular portion, a tubular connecting portion composed of the first tubular portion and the second tubular portion, and a winding/pressing portion for limiting a separation distance between a first inner surface of the first tubular portion and a second inner surface of the second tubular portion, the tubular connecting portion being a first connecting portion, a columnar connecting portion of a male terminal being inserted into the first connecting portion, the first connecting portion being electrically connected to the columnar connecting portion, the winding/pressing portion being integrally formed to the first peripheral wall, and the winding/pressing portion being folded from the first peripheral wall while embracing an end edge of the second peripheral wall inside, the winding/pressing portion being held in contact with an outer surface of the second peripheral wall.

According to this configuration, when the columnar connecting portion of the male terminal is press-fit into the tubular connecting portion, an increase in separation distance between the first inner surface of the first tubular portion and the second inner surface of the second tubular portion is limited by the winding/pressing portion. By this limitation by the winding/pressing portion, the first and second inner surfaces can be suitably brought into contact with the outer peripheral surface of the columnar connecting portion. As a result, the tubular connecting portion and the columnar connecting portion can be stably held in a contact state. Further, the winding/pressing portion is integrally formed to the first peripheral wall. Thus, the contact state of the tubular connecting portion and the columnar connecting portion can be held by a simple structure as compared to a conventional technique using a separate component such as a coil spring. That is, the structure of the female terminal can be simplified as compared to the conventional technique using the separate component such as a coil spring.

[2] In [1] described above, the female terminal may be further provided with a coupling portion coupling the first peripheral wall and the second peripheral wall, and the coupling portion may be integrally formed to the first peripheral wall and integrally formed to the second peripheral wall.

According to this configuration, the first and second peripheral walls are coupled by the coupling portion integrally formed to the both first and second peripheral walls. In this way, the first and second peripheral walls can be integrally formed through the coupling portion. Thus, the female terminal can be configured, such as by bending one metal plate. As a result, the structure of the female terminal can be simplified.

[3] In [2] described above, the first peripheral wall may be formed into a strip shape extending along a first direction, the second peripheral wall may be formed into a strip shape extending along the first direction, the first inner surface may be a surface facing in a second direction intersecting the first direction, the second inner surface may be a surface facing in a second opposite direction opposite to the second direction, the winding/pressing portion may be folded toward the second peripheral wall from an end surface in a third direction intersecting both the first direction and the second direction, out of the first peripheral wall, and the coupling portion may be formed to be folded from an end surface in a third opposite direction opposite to the third direction, out of the first peripheral wall, toward an end surface in the third opposite direction, out of the second peripheral wall.

According to this configuration, the winding/pressing portion is provided on a side opposite to the coupling portion across the first peripheral wall. Thus, the opening of the coupling portion, i.e. an increase in separation distance between the first and second peripheral walls can be suitably limited by the winding/pressing portion. As a result, an increase in separation distance between the first and second inner surfaces can be suitably limited by the winding/pressing portion.

[4] In [3] described above, the winding/pressing portion may project further in the third direction than the end surface in the third direction of the first peripheral wall, the coupling portion may project further in the third opposite direction than the end surface in the third opposite direction of the first peripheral wall, and a first projection amount of the winding/pressing portion from the end surface in the third direction of the first peripheral wall may be equal to a second projection amount of the coupling portion from the end surface in the third opposite direction of the first peripheral wall.

According to this configuration, the first projection amount of the winding/pressing portion folded toward the second peripheral wall from the end surface in the third direction of the first peripheral wall is equal to the second projection amount of the coupling portion folded toward the second peripheral wall from the end surface in the third opposite direction of the first peripheral wall. Thus, the winding/pressing portion and the coupling portion can be formed into nearly symmetrical shapes. In this way, the female terminal can be accommodated even if the winding/pressing portion is in a posture facing a first space capable of accommodating the winding/pressing portion or the coupling portion is in a posture facing the first space. As a result, the limitation of an insertion direction of the female terminal into the first space can be mitigated. Therefore, the versatility of the female terminal can be improved.

[5] In [3] or [4] described above, the female terminal may be further provided with a projection projecting in the third direction from an end surface in the third direction of the second peripheral wall, the winding/pressing portion may include a through hole to be fit to the projection and an engagement surface constituting the through hole and facing in the second direction, and the engagement surface may be engaged with the projection.

According to this configuration, the second peripheral wall is pressed by the winding/pressing portion, and the winding/pressing portion is pressed by the projection by the engagement of the projection with the engagement surface. In this way, an increase in separation distance between the first and second inner surfaces can be stably limited.

[6] In any one of [3] to [5] described above, the female terminal may be further provided with a protecting portion provided on an end part in the first direction of the first peripheral wall, the protecting portion may be integrally formed to the first peripheral wall, the protecting portion may be formed to be folded from the end part in the first direction of the first peripheral wall while arranging an end part in the first direction of the second peripheral wall inside, the protecting portion may include a protection wall provided to face the end part in the first direction of the second peripheral wall in the second direction, and the protection wall may be provided away from the end part in the first direction of the second peripheral wall.

According to this configuration, the protection wall of the protecting portion integrally formed to the first peripheral wall is provided to face the end part in the first direction of the second peripheral wall while being separated therefrom. Thus, the deformation of the second peripheral wall can be suitably hindered by the protection wall, for example, even if an excessive external force is accidentally applied to the end part in the first direction of the second peripheral wall and the second peripheral wall is deformed away from the first peripheral wall due to that external force.

[7] In [6] described above, the winding/pressing portion may be provided on an end part in a first opposite direction opposite to the first direction, out of the first peripheral wall, and the tubular connecting portion may be provided at an intermediate position between the winding/pressing portion and the protecting portion in the first direction.

According to this configuration, the winding/pressing portion is provided at a position different from the tubular connecting portion in the first direction. An increase in separation distance between the first and second peripheral walls can be limited by such a winding/pressing portion. Consequently, an increase in separation distance between the first inner surface constituting the tubular connecting portion and the second inner surface constituting the tubular connecting portion can be limited by the winding/pressing portion.

[8] In [6] or [7] described above, the second tubular portion may be provided at an intermediate position of the second peripheral wall in the first direction, the protecting portion may include an extending portion extending in the second direction from the end part in the first direction of the first peripheral wall, the protection wall extending in a first opposite direction opposite to the first direction from an end part in the second direction of the extending portion, and an opening hole penetrating through the extending portion in the first direction to expose an end surface in the first direction of the second peripheral wall, and the opening hole may be formed to expose an end edge in the second direction of the first peripheral wall and an end edge in the second opposite direction of the second peripheral wall.

According to this configuration, the opening hole is provided which penetrates through the extending portion of the protecting portion in the first direction and exposes the end edge in the second direction of the first peripheral wall and the end edge in the second opposite direction of the second peripheral wall. In this way, a laser can be irradiated to the first and second peripheral walls, for example, through the opening hole. That is, the laser can be irradiated to the first and second peripheral walls of the female terminal from a position separated from the end surface in the first direction of the female terminal in the first direction. A distance between the end edge in the second direction of the first peripheral wall and the end edge in the second opposite direction of the second peripheral wall can be measured by irradiating such a laser. That is, a gap between the first and second peripheral walls can be measured by irradiating the laser.

[9] In [8] described above, the second tubular portion may include two divided tubular portions divided in an axial direction of the tubular connecting portion and a slit dividing the two divided tubular portions, each of the plurality of divided tubular portions may include the second inner surface and a protrusion arcuately projecting radially inwardly of the tubular connecting portion from the second inner surface in a cross-section and the slit may be provided at a center position of the tubular connecting portion in the axial direction.

According to this configuration, the slit dividing the two divided tubular portions is provided at the center position in the axial direction of the tubular connecting portion. At this time, when the columnar connecting portion of the male terminal inserted in the tubular connecting portion is displaced, the columnar connecting portion rotates with a center in the axial direction of the tubular connecting portion as a center of rotation. If a contact part of the protrusion and the columnar connecting portion is provided at such a center of rotation, a contact pressure by the protrusion cannot be exerted as a force for suppressing a displacement of the columnar connecting portion. In contrast, in the above configuration, the protrusion is provided at a position different from the slit provided in the center in the axial direction of the tubular connecting portion. Thus, the protrusion and the columnar connecting portion can be brought into contact at a position different from the center of rotation in a displacement of the columnar connecting portion. In this way, the contact pressure by the protrusion can be suitably exerted as a force for suppressing the displacement of the columnar connecting portion. As a result, the displacement of the columnar connecting portion inside the tubular connecting portion can be suitably suppressed by contact pressures by a plurality of the protrusions. Further, in the tubular connecting portion, the two protrusions are brought into contact with the outer peripheral surface of the columnar connecting portion at two positions separated in the axial direction. In this way, the displacement of the columnar connecting portion inside the tubular connecting portion can be suppressed by contact pressures by the two protrusions as compared to the case where only one protrusion is provided on the second inner surface of the second tubular portion.

[10] In [9] described above, the slit may be formed to extend in the first opposite direction from the end surface in the first direction of the second peripheral wall, the second peripheral wall may include two divided portions divided by the slit, and the opening hole may be formed to expose an end edge in the second opposite direction of the second peripheral wall in each of the two divided portions.

According to this configuration, the opening hole is formed to expose the end edge in the second opposite direction of the second peripheral wall in each of the plurality of divided portions. Thus, by irradiating a laser to the first and second peripheral walls through an opening, a distance between the end edge in the second opposite direction of the second peripheral wall and the end edge in the second direction of the first peripheral wall in each of the plurality of divided portions can be measured.

[11] In any one of [6] to [10] described above, the female terminal may be further provided with a wire connecting portion provided on an end part in a first opposite direction opposite to the first direction, out of the first peripheral wall, the wire connecting portion may be a second connecting portion to be electrically connected to a wire, the wire connecting portion may be integrally formed to the first peripheral wall, and the wire connecting portion may extend in the first opposite direction from an end part in the first opposite direction of the first peripheral wall.

According to this configuration, the wire connecting portion to be electrically connected to the wire is integrally formed to the first peripheral wall. Thus, the number of components of the female terminal can be reduced, and the structure of the female terminal can be simplified.

[12] In any one of [1] to [11] described above, the tubular connecting portion may include a plurality of linear contact portions projecting radially inwardly of the tubular connecting portion from the first inner surface and provided away from each other in a circumferential direction of the tubular connecting portion, and each of the plurality of linear contact portions may extend along an axial direction of the tubular connecting portion.

According to this configuration, when the columnar connecting portion of the male terminal is press-fit into the tubular connecting portion, the linear contact portions provided on the first inner surface constituting the tubular connecting portion are pressed into line contact with the outer peripheral surface of the columnar connecting portion at a plurality of positions separated in the circumferential direction. In this way, for example, even if a swinging movement is transmitted to the male terminal, a displacement of the male terminal due to that swinging movement can be hindered by the contact of the male terminal with the plurality of linear contact portions.

[13] In any one of [1] to [8] described above, the second inner surface may be formed to be arcuately recessed radially outwardly of the tubular connecting portion in a cross-section, and the tubular connecting portion may include a protrusion arcuately projecting radially inwardly of the tubular connecting portion from the second inner surface in a cross-section.

According to this configuration, when the columnar connecting portion of the male terminal is press-fit into the tubular connecting portion, the protrusion arcuately projecting radially inwardly from the second inner surface constituting the tubular connecting portion in a cross-section is pressed into contact with the outer peripheral surface of the columnar connecting portion. In this way, since the protrusion can be pressed into contact with the outer peripheral surface of the columnar connecting portion with a high contact pressure, a press-contact state of the tubular connecting portion and the columnar connecting portion can be stably held.

[14] A connector of the present disclosure is provided with the female terminal of any one of [1] to [13] described above, and a housing for accommodating the female terminal inside.

According to this configuration, effects similar to those of the female terminal of [1] described above can be obtained.

### Details of Embodiments of Present Disclosure

Specific examples of a connector and a female terminal of the present disclosure are described below with reference to the drawings. For the convenience of description, some components may be shown in an exaggerated or simplified manner in each drawing. Further, a dimension ratio of each part may be different in each figure. “Parallel” and “orthogonal” in this specification mean not only strictly parallel and orthogonal, but also substantially parallel and orthogonal within a range in which functions and effects in this embodiment are achieved. In this specification, a term “equal” also means a case where objects to be compared are slightly different due to dimensional tolerances and the like, in addition to meaning exactly equal. A term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape and a U shape. Note that “tubular” shapes include circular shapes, elliptical shapes and polygonal shapes with angular or round corners, but there is no limitation to these. “Facing each other” in this specification indicates that surfaces or members are at positions in front of each other, and means not only a case where the surfaces or members are at positions perfectly in front of each other, but also a case where the surfaces or members are partially in front of each other. Further, “facing each other” in this specification means both a case where another member different from two parts is interposed between the two parts and a case where nothing is interposed between the two parts. Further, terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

### First Embodiment

Hereinafter, a female terminal and a connector of a first embodiment are described.

### Overall Configuration of Wiring Harness W1

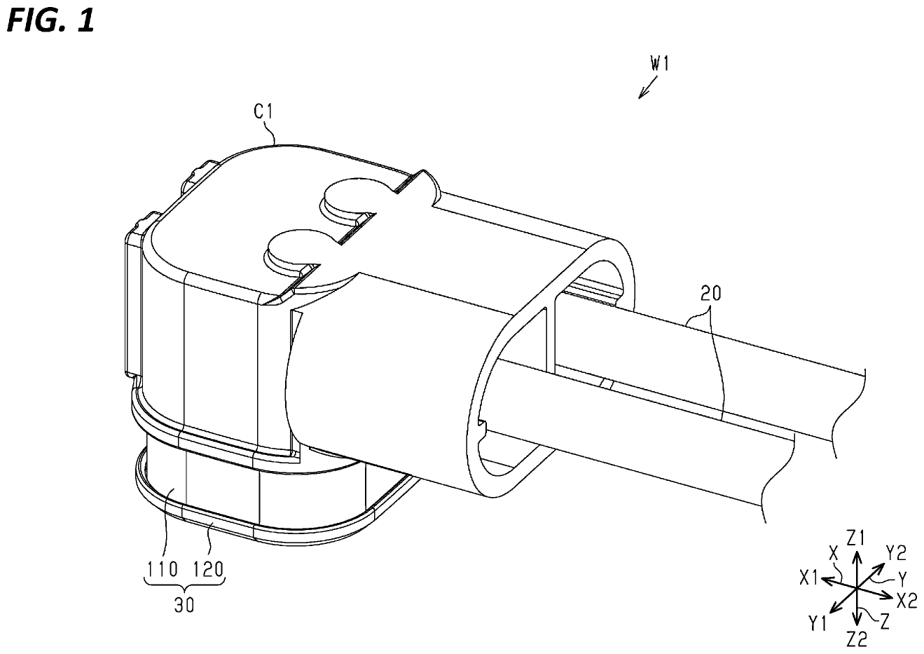

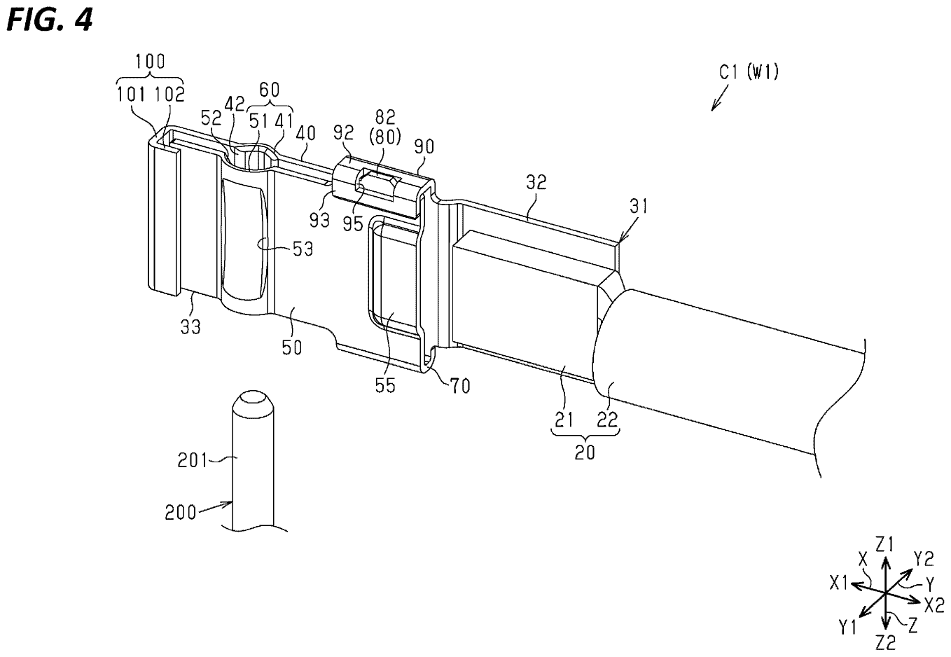

As shown in FIG. 1, a wiring harness W1 is provided with one or more (two in this embodiment) wires 20 and a connector C1 mounted on end parts of the wires 20. The wiring harness W1 is, for example, for electrically connecting electrical devices for vehicle. An inverter and a wheel drive motor can be, for example, cited as the electrical devices for vehicle. Although not shown in detail, the connector C1 is electrically connected to a mating connector provided on the electrical device. The mating connector is, for example, provided with one or more (two in this embodiment) male terminals 200 as mating terminals (see FIG. 4) and a mating housing for holding the two male terminals 200. Note that respective directions in each figure do not necessarily indicate the postures of the connector C1 and the wiring harness W1 during usage.

### Overall Configuration of Connector C1

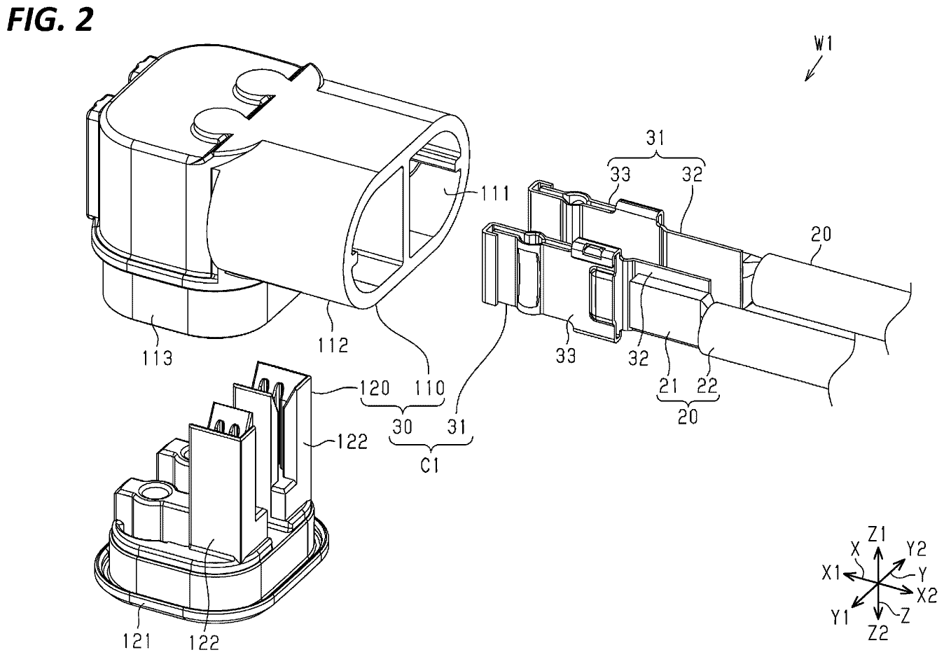

As shown in FIG. 2, the connector C1 is provided with a housing 30 and a plurality of female terminals 31 respectively connected to end parts of a plurality of wires 20. The housing 30 holds a plurality of the female terminals 31. The housing 30 includes a housing body 110 for accommodating the female terminals 31 inside and a retainer 120 to be mounted into the housing body 110. Note that an X axis, a Y axis and a Z axis orthogonal to each other are shown in each figure. In each figure, a first direction X1, which is one of X-axis directions along the X axis, and a first opposite direction X2, which is a direction opposite to the first direction X1, are shown. In each figure, a second direction Y1, which is one of Y-axis directions along the Y axis, and a second opposite direction Y2, which is a direction opposite to the second direction Y1, are shown. In each figure, a third direction Z1, which is one of Z-axis directions along the Z axis, and a third opposite direction Z2, which is a direction opposite to the third direction Z1, are shown. Each direction described above is a direction in a state where the connector C1 is mounted on the end parts of the wires 20 unless otherwise specified.

The female terminals 31 and the wires 20 are inserted into the housing body 110 along the first direction X1. The retainer 120 is mounted into the housing body 110 along the third direction Z1. The mating connector is connected to the connector C1, for example, along the third direction Z1. For example, the male terminals 200 (see FIG. 4) of the mating connector are inserted into the housing body 110 along the third direction Z1.

### Configuration of Wire 20

Each wire 20 includes an electrically conductive core wire 21 and an insulating insulation coating 22 surrounding the outer periphery of the core wire 21. A stranded wire formed by twisting a plurality of metal strands or a single core wire constituted by a single conductor can be, for example, used as the core wire 21. A copper-based or aluminum-based metal material can be, for example, used as a material of the core wire 21. The insulation coating 22 covers, for example, the outer peripheral surface of the core wire 21 over the entire periphery in a circumferential direction. The insulation coating 22 is, for example, made of an insulating resin material.

An end part in the first direction X1 of the core wire 21 is exposed from the insulation coating 22. The female terminal 31 is connected to the end part in the first direction X1 of the core wire 21 exposed from the insulation coating 22.

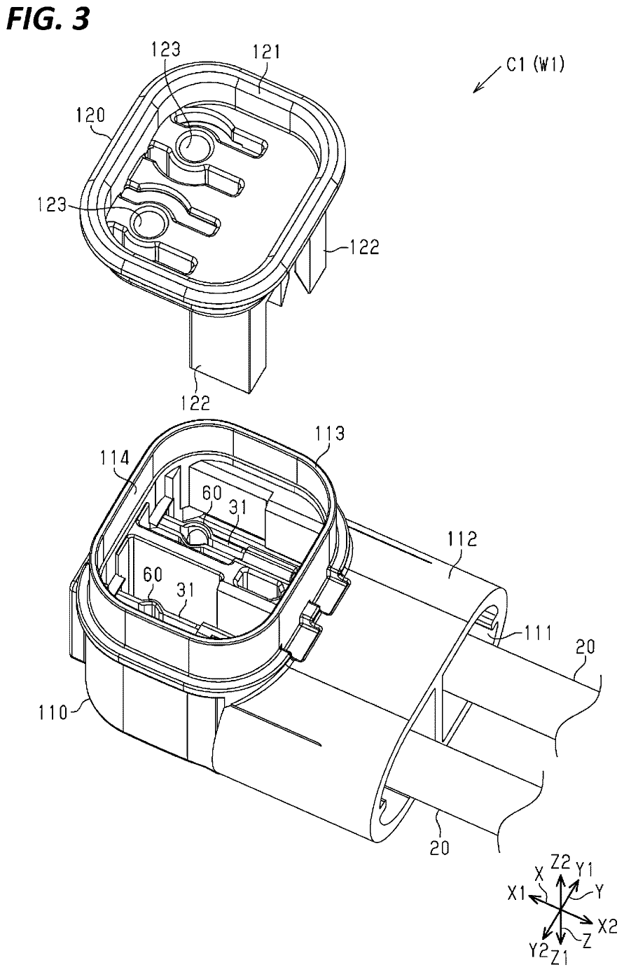

As shown in FIG. 3, an end part in the first direction X1 of the wire 20 is accommodated inside the housing body 110. The wire 20 is drawn out in the first opposite direction X2 from an end part in the first opposite direction X2 of the housing body 110.

### Configuration of Female Terminals 31

As shown in FIG. 2, the two female terminals 31 are respectively electrically connected to the two wires 20. The two female terminals 31 are provided side by side along the Y-axis direction. The two female terminals 31 have, for example, the same structure. Here, description is given, focusing on the female terminal 31 provided on the second direction Y1 side, out of the two female terminals 31.

Each female terminal 31 includes a wire connecting portion 32 to be connected to the end part of the wire 20 and a terminal connecting portion 33 extending in the first direction X1 from an end part in the first direction X1 of the wire connecting portion 32. Each female terminal 31 is, for example, a single component in which the wire connecting portion 32 and the terminal connecting portion 33 are continuously and integrally formed. Each female terminal 31 is configured, for example, by bending a metal plate material or combining metal plate materials. Each female terminal 31 of this embodiment is configured by bending one metal plate material. Each female terminal 31 is, for example, made of metal. A copper-based or aluminum-based metal material can be, for example, used as a material of each female terminal 31.

The wire connecting portion 32 is connected to the end part of the core wire 21 exposed from the insulation coating 22. The wire connecting portion 32 is, for example, in the form of a flat plate. The wire connecting portion 32 is, for example, in the form of a stipe extending along the X-axis direction. The wire connecting portion 32 is, for example, connected to the core wire 21 by crimping, ultrasonic welding or the like. In this way, the wire connecting portion 32 and the core wire 21 are electrically and mechanically connected.

As shown in FIG. 4, the terminal connecting portion 33 is a female terminal portion to be connected to the male terminal 200 of the mating connector. Here, the male terminal 200 includes a column-like columnar connecting portion 201. The columnar connecting portion 201 of this embodiment is formed into a cylindrical shape.

The terminal connecting portion 33 includes a first peripheral wall 40 having a first tubular portion 41 and a second peripheral wall 50 having a second tubular portion 51 facing the first tubular portion 41. The terminal connecting portion 33 includes a tubular connecting portion 60 composed of the first and second tubular portions 41, 51. The terminal connecting portion 33 includes, for example, a coupling portion 70, a projecting portion 80, a winding/pressing portion 90 and a protecting portion 100. The first and second peripheral walls 40, 50 are facing each other in the Y-axis direction.

### Configurations of First Peripheral Wall 40 and Second Peripheral Wall 50

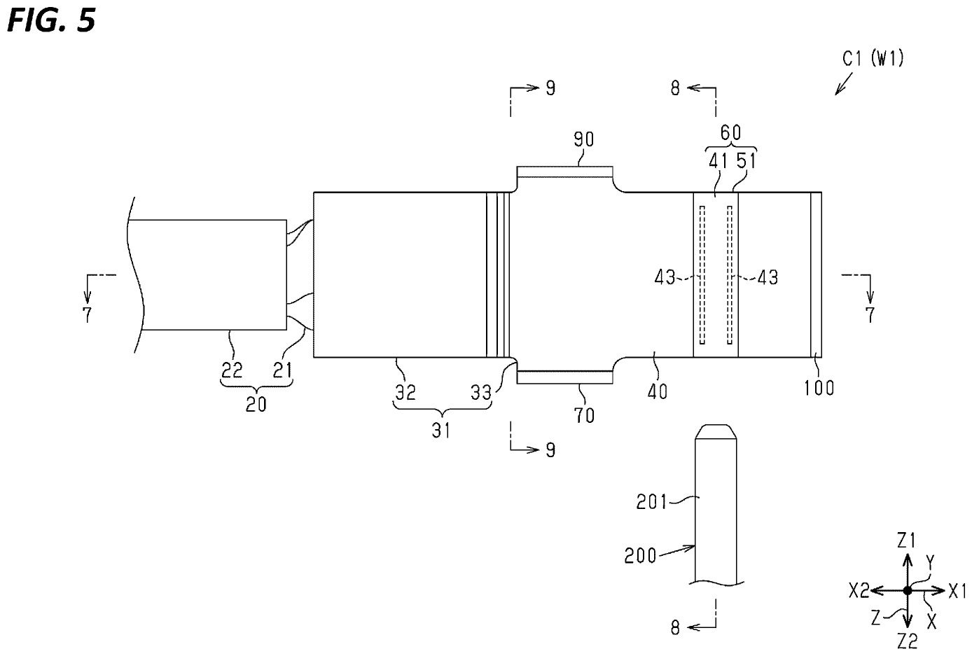

As shown in FIGS. 4 and 5, an end part in the first opposite direction X2 of the first peripheral wall 40 is connected to the end part in the first direction X1 of the wire connecting portion 32. The first peripheral wall 40 is in the form of a strip extending along the first direction X1. The first peripheral wall 40 extends, for example, in the first direction X1 from the end part in the first direction X1 of the wire connecting portion 32. In other words, the wire connecting portion 32 extends in the first opposite direction X2 from an end part in the first opposite direction X2 of the first peripheral wall 40. The first peripheral wall 40 is, for example, in the form of a flat plate. The first peripheral wall 40 has a predetermined width along the Z-axis direction. As shown in FIG. 4, the first peripheral wall 40 has a predetermined thickness along the Y-axis direction. The first peripheral wall 40 has an inner surface facing the second peripheral wall 50 and an outer surface provided on a side opposite to the inner surface in the Y-axis direction.

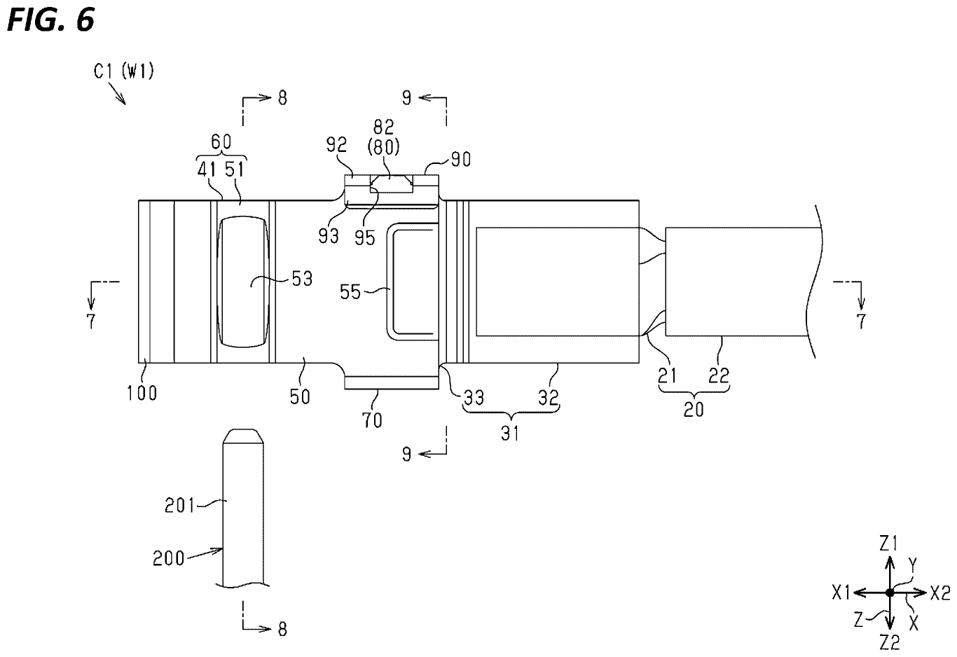

As shown in FIGS. 4 and 6, the second peripheral wall 50 is in the form of a strip extending along the first direction X1. The second peripheral wall 50 is, for example, in the form of a flat plate. The second peripheral wall 50 has a predetermined width along the Z-axis direction. As shown in FIG. 4, the second peripheral wall 50 has a predetermined thickness along the Y-axis direction. The second peripheral wall 50 has an inner surface facing the inner surface of the first peripheral wall 40 and an outer surface provided on a side opposite to the inner surface in the Y-axis direction. The inner surface of the second peripheral wall 50 is, for example, provided away from the inner surface of the first peripheral wall 40 in the Y-axis direction. The second peripheral wall 50 extends, for example, in parallel to the first peripheral wall 40.

The first tubular portion 41 is provided at an intermediate position in the X-axis direction of the first peripheral wall 40. The first tubular portion 41 is provided between the winding/pressing portion 90 and the protecting portion 100 in the X-axis direction. The first tubular portion 41 is, for example, formed into a half tube shape as a whole. As shown in FIG. 5, the first tubular portion 41 extends along the Z-axis direction. The first tubular portion 41 extends over the entire length in the Z-axis direction of the first peripheral wall 40.

As shown in FIG. 4, the second tubular portion 51 is provided at an intermediate position in the X-axis direction of the second peripheral wall 50. The second tubular portion 51 is provided between the winding/pressing portion 90 and the protecting portion 100 in the X-axis direction. The second tubular portion 51 is, for example, formed into a half tube shape as a whole. The second tubular portion 51 extends along the Z-axis direction. The second tubular portion 51 extends over the entire length in the Z-axis direction of the second peripheral wall 50.

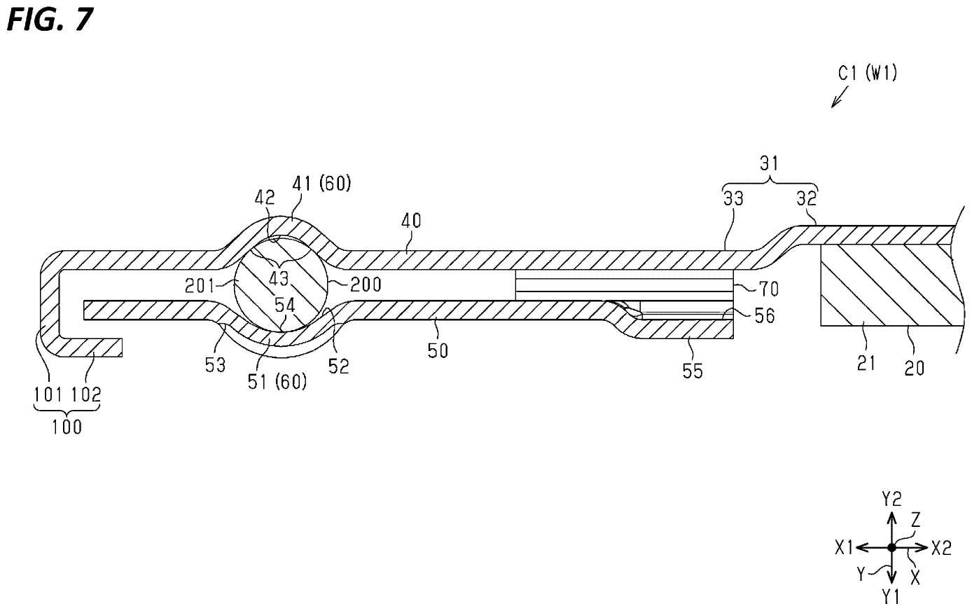

As shown in FIG. 7, the first tubular portion 41 has a first inner surface 42 facing in the second direction Y1. The second tubular portion 51 has a second inner surface 52 facing in the second opposite direction Y2. The first and second inner surfaces 42, 52 are facing each other in the Y-axis direction. The first and second tubular portions 41, 51 are curved in directions separating from each other. An internal space of the tubular connecting portion 60 is formed by the first inner surface 42 of the first tubular portion 41 and the second inner surface 52 of the second tubular portion 51. The tubular connecting portion 60 is a connecting part, into which the columnar connecting portion 201 of the male terminal 200 is inserted and which is electrically connected to the columnar connecting portion 201. As shown in FIG. 4, an axial direction of the tubular connecting portion 60 is a direction intersecting an extension direction of the wire 20 (here, the X-axis direction) and, in this embodiment, extends along the Z-axis direction. The tubular connecting portion 60 is open on both ends in the Z-axis direction. That is, the tubular connecting portion 60 is open in the third direction Z1 and also in the third opposite direction Z2. The columnar connecting portion 201 is inserted into the tubular connecting portion 60 of this embodiment along the third direction Z1.

As shown in FIG. 7, the tubular connecting portion 60 is, for example, formed into a hollow cylindrical portion as a whole. The tubular connecting portion 60 has, for example, a minimum inner diameter smaller than a maximum outer diameter of the columnar connecting portion 201. That is, the tubular connecting portion 60 is so configured that the columnar connecting portion 201 is press-fit thereinto.

The outer surface of the first tubular portion 41 is formed into a curved surface having an arcuate cross-sectional shape obtained by cutting the first tubular portion 41 by a plane parallel to the X-axis direction. The outer surface of the first tubular portion 41 is formed to arcuately project radially outwardly of the tubular connecting portion 60 in a cross-section. Similarly, the first inner surface 42 of the first tubular portion 41 is formed to be arcuately recessed radially outwardly of the tubular connecting portion 60 in a cross-section.

The first inner surface 42 of the first tubular portion 41 is provided with a plurality of (two in this embodiment) linear contact portions 43 projecting radially inwardly of the tubular connecting portion 60 from the inner surface 42. The two linear contact portions 43 are provided at positions separated from each other in a circumferential direction of the tubular connecting portion 60. The two linear contact portions 43 are, for example, provided to partially face each other in the X-axis direction. As shown in FIG. 5, each linear contact portion 43 extends along the axial direction of the tubular connecting portion 60 (here, the Z-axis direction).

As shown in FIG. 7, a curvature of the first inner surface 42 having the two linear contact portions 43 is set to be smaller than that of the outer peripheral surface of the columnar connecting portion 201 of the male terminal 200. In this way, the two linear contact portions 43 can be suitably brought into contact with the outer peripheral surface of the columnar connecting portion 201. At this time, each linear contact portion 43 is linearly held in contact with the outer peripheral surface of the columnar connecting portion 201 along the axial direction of the tubular connecting portion 60. That is, each linear contact portion 43 linearly contacts the outer peripheral surface of the columnar connecting portion 201.

The outer surface of the second tubular portion 51 is formed into a curved surface having an arcuate cross-sectional shape obtained by cutting the second tubular portion 51 by a plane parallel to the X-axis direction. The outer surface of the second tubular portion 51 is formed to arcuately project radially outwardly of the tubular connecting portion 60 in a cross-section. Similarly, the second inner surface 52 of the second tubular portion 51 is formed to be arcuately recessed radially outwardly of the tubular connecting portion 60 in a cross-section.

As shown in FIGS. 4 and 6, the outer surface of the second tubular portion 51 is provided with a dent portion 53 dented radially inwardly of the tubular connecting portion 60 from the outer surface. As shown in FIG. 6, the dent portion 53 is, for example, formed into a rectangular planar shape when viewed from the Y-axis direction. The dent portion 53 is, for example, provided at an intermediate position in the Z-axis direction of the second tubular portion 51 and at an intermediate position in the X-axis direction of the second tubular portion 51.

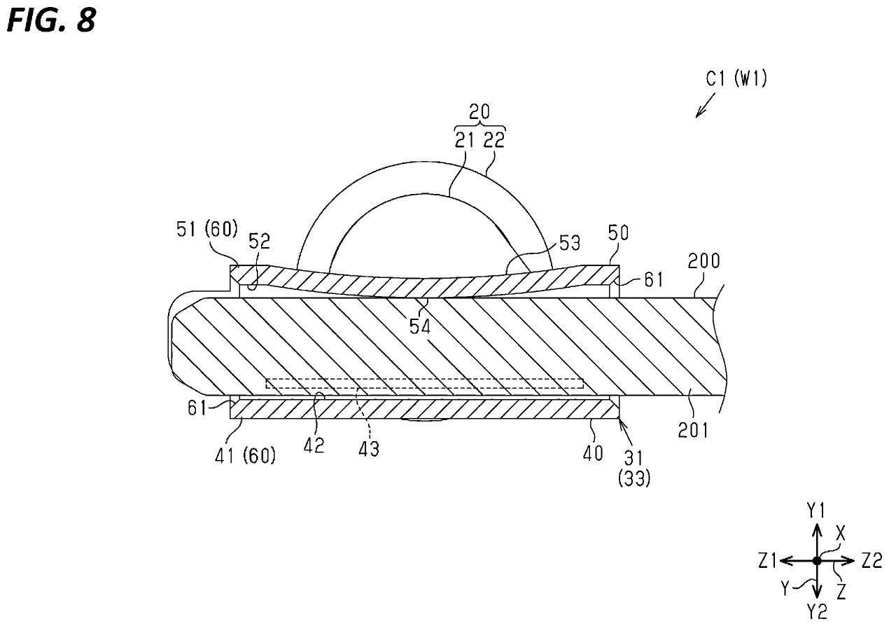

As shown in FIG. 8, the second inner surface 52 of the second tubular portion 51 is provided with a protrusion 54 projecting radially inwardly of the tubular connecting portion 60 from the second inner surface 52. The protrusion 54 is, for example, provided on the second inner surface 52 of the second tubular portion 51 in a part where the dent portion 53 is formed. The protrusion 54 is, for example, formed to have a cross-sectional shape obtained by cutting the protrusion 54 by a plane parallel to the axial direction of the tubular connecting portion 60 (here, the Z-axis direction) and arcuately projecting radially inwardly of the tubular connecting portion 60. The protrusion 54 is formed to arcuately project radially inwardly of the tubular connecting portion 60 from the second inner surface 52 in a cross-section. The protrusion 54 extends, for example, along the circumferential direction of the tubular connecting portion 60. The protrusion 54 extends, for example, along the axial direction of the tubular connecting portion 60. The protrusion 54 is in point contact with the outer peripheral surface of the columnar connecting portion 201 of the male terminal 200. The protrusion 54 can be, for example, formed by embossing. The protrusion 54 is formed into an embossed shape by pressurizing the outer surface of the second tubular portion 51 by a die.

Each of both end parts in the axial direction of the tubular connecting portion 60 includes, for example, a guiding portion 61. Each guiding portion 61 is formed to increase an opening width (here, an inner diameter) of the tubular connecting portion 60 toward an opening end in the axial direction of the tubular connecting portion 60. Each guiding portion 61 is, for example, formed by inclining the inner surface of the tubular connecting portion 60 radially outwardly of the tubular connecting portion 60 toward the opening end of the tubular connecting portion 60. Each guiding portion 61 is, for example, formed over the entire periphery in the circumferential direction of the first inner surface 42 of the first tubular portion 41 and formed over the entire periphery in the circumferential direction of the second inner surface 52 of the second tubular portion 51. Each guiding portion 61 functions to smoothly guide the columnar connecting portion 201 into the tubular connecting portion 60 when the columnar connecting portion 201 of the male terminal 200 is inserted into the tubular connecting portion 60. Since such guiding portions 61 are provided on the both end parts in the axial direction of the tubular connecting portion 60, insertion resistance can be caused to similarly change, regardless of in which of the both end parts in the axial direction of the tubular connecting portion 60 an insertion opening into the tubular connecting portion 60 for the male terminal 200 is set. Thus, the limitation of an insertion direction of the male terminal 200 with respect to the axial direction of the tubular connecting portion 60 can be eliminated.

As shown in FIG. 4, the second peripheral wall 50 includes a convex portion 55 projecting from the outer surface of the second peripheral wall 50. The convex portion 55 projects in the second direction Y1 from the outer surface of the second peripheral wall 50. The convex portion 55 is provided at a position overlapping the winding/pressing portion 90 in a plan view viewed from the Z-axis direction. The convex portion 55 is, for example, provided on an end part in the first opposite direction X2 of the second peripheral wall 50. The convex portion 55 extends, for example, in the first direction X1 from an end surface in the first opposite direction X2 of the second peripheral wall 50. The convex portion 55 does not extend up to the second tubular portion 51 in the X-axis direction. The convex portion 55 is, for example, provided at an intermediate position in the Z-axis direction of the second peripheral wall 50. The convex portion 55 is, for example, formed into a rectangular planar shape when viewed from the Y-axis direction. The convex portion 55 can be, for example, formed by embossing. The convex portion 55 is formed into an embossed shape by pressurizing the inner surface of the second peripheral wall 50 by a die.

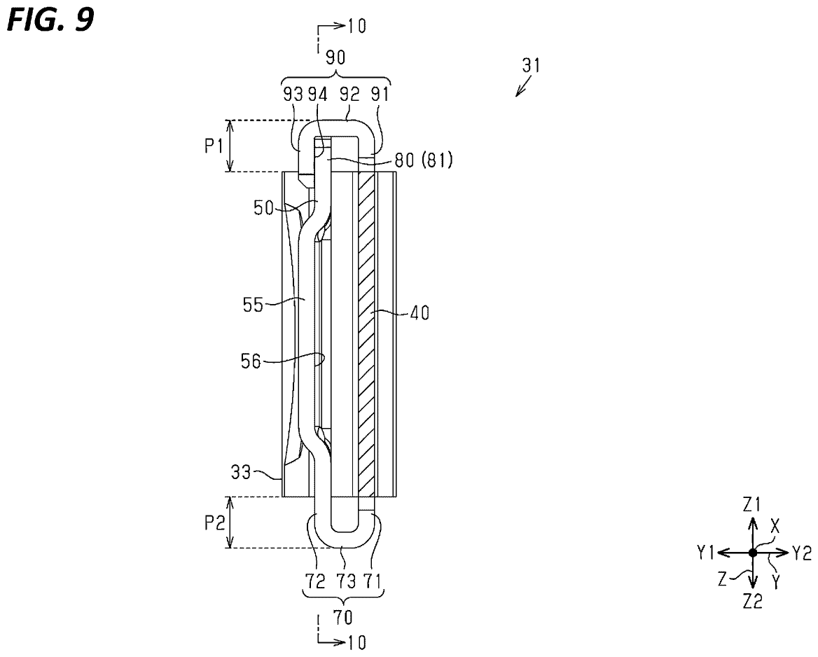

As shown in FIG. 9, the second peripheral wall 50 is provided with a concave portion 56 in the inner surface of a part where the convex portion 55 is formed. The concave portion 56 is formed to be recessed in a direction separating from the first peripheral wall 40 from the inner surface of the second peripheral wall 50.

### Configuration of Coupling Portion 70

As shown in FIG. 4, the coupling portion 70 couples the first and second peripheral walls 40, 50. The coupling portion 70 couples an end part in the third opposite direction Z2 of the first peripheral wall 40 and an end part in the third opposite direction Z2 of the second peripheral wall 50. The coupling portion 70 is integrally formed to the first peripheral wall 40 and integrally formed to the second peripheral wall 50. The coupling portion 70 is formed to extend in the second direction Y1 from an end surface in the third opposite direction Z2 of the first peripheral wall 40 toward an end surface in the third opposite direction Z2 of the second peripheral wall 50. The coupling portion 70 is formed to be folded from the end surface in the third opposite direction Z2 of the first peripheral wall 40 toward the end surface in the third opposite direction Z2 of the second peripheral wall 50.

The coupling portion 70 is, for example, provided on an end part in the first opposite direction X2 of the terminal connecting portion 33. The coupling portion 70 is provided on an end part in the first opposite direction X2 of the first peripheral wall 40. The coupling portion 70 extends in the first direction X1 from the end part in the first opposite direction X2 of the first peripheral wall 40. The coupling portion 70 projects further in the third opposite direction Z2 than the end surface in the third opposite direction Z2 of the first peripheral wall 40 and projects further in the third opposite direction Z2 than the end surface in the third opposite direction Z2 of the second peripheral wall 50.

As shown in FIG. 9, the coupling portion 70 includes an extending portion 71 extending in the third opposite direction Z2 from the end surface in the third opposite direction Z2 of the first peripheral wall 40 and an extending portion 72 extending in the third opposite direction Z2 from the end surface in the third opposite direction Z2 of the second peripheral wall 50. The coupling portion 70 includes a folded portion 73 linking the extending portions 71, 72.

The extending portion 71 is formed to be continuous and integral with the first peripheral wall 40. The folded portion 73 is formed to be continuous and integral with the extending portion 71. The folded portion 73 is formed to be folded toward the second peripheral wall 50 from an end part of the extending portion 71. The folded portion 73 is, for example, folded in the third direction Z1 into a U shape from the end part of the extending portion 71. The extending portion 72 extends in the third direction Z1 from the folded portion 73 toward the second peripheral wall 50. The extending portion 72 is formed to be continuous and integral with the folded portion 73 and formed to be continuous and integral with the second peripheral wall 50. The coupling portion 70 is folded into a U shape convex in a direction separating from the first and second peripheral walls 40, 50 (here, in the third opposite direction Z2) by the extending portion 71, the folded portion 73 and the extending portion 72. The coupling portion 70 is so folded that the second peripheral wall 50 is arranged to face the first peripheral wall 40. In other words, in the terminal connecting portion 33, the second peripheral wall 50 is folded into two toward the first peripheral wall 40 by the coupling portion 70.

### Configuration of Projecting Portion 80

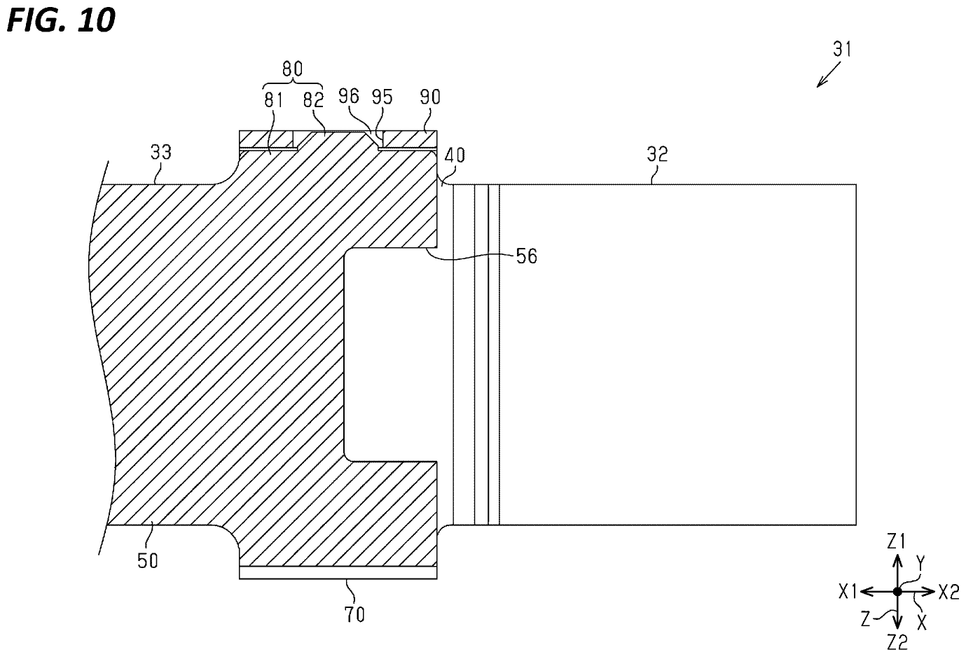

As shown in FIG. 10, the projecting portion 80 is provided on an end surface in the third direction Z1 of the second peripheral wall 50. The projecting portion 80 includes, for example, a projecting base portion 81 extending in the third direction Z1 from the end surface in the third direction Z1 of the second peripheral wall 50 and a projection 82 extending in the third direction Z1 from a part of the projecting tip surface of the projecting base portion 81. The projecting base portion 81 is formed to be continuous and integral with the second peripheral wall 50. The projecting base portion 81 extends along the first direction X1 from an end surface in the first opposite direction X2 of the second peripheral wall 50. The projection 82 is formed to be continuous and integral with the projecting base portion 81. The projection 82 projects further in the third direction Z1 than the projecting tip surface, here, the end surface in the third direction Z1, of the projecting base portion 81. The projection 82 is, for example, provided only at an intermediate position in the X-axis direction of the projecting base portion 81. The projection 82 is, for example, formed to reduce a width along the X-axis direction toward the projecting tip surface of the projection 82 from the projecting base portion 81 in a plan view viewed from the Y-axis direction.

### Configuration of Winding/Pressing Portion 90

As shown in FIG. 4, the winding/pressing portion 90 is formed to limit a separation distance between the first inner surface 42 of the first tubular portion 41 and the second inner surface 52 of the second tubular portion 51. The winding/pressing portion 90 limits an increase in separation distance between the first and second inner surfaces 42, 52. The winding/pressing portion 90 limits the opening of the coupling portion 70. The winding/pressing portion 90 is integrally formed to the first peripheral wall 40. The winding/pressing portion 90 is, for example, provided on the end part in the third direction Z1 of the first peripheral wall 40. The winding/pressing portion 90 is, for example, formed to be folded from the first peripheral wall 40 while embracing an end surface of the second peripheral wall 50 inside. The winding/pressing portion 90 is, for example, formed to be folded from the end surface in the third direction Z1 of the first peripheral wall 40 while arranging the end edge in the third direction Z1 of the second peripheral wall 50 inside. The winding/pressing portion 90 is in contact with the outer surface of the second peripheral wall 50.

The winding/pressing portion 90 is, for example, provided on the end part in the first opposite direction X2 of the terminal connecting portion 33. The winding/pressing portion 90 is provided on the end part in the first opposite direction X2 of the first peripheral wall 40. The winding/pressing portion 90 extends in the first direction X1 from the end part in the first opposite direction X2 of the first peripheral wall 40. The winding/pressing portion 90 is provided at a position overlapping the coupling portion 70 in a plan view viewed from the Z-axis direction. For example, the winding/pressing portion 90 is provided on a side opposite to the coupling portion 70 across the first peripheral wall 40 in the Z-axis direction.

As shown in FIG. 9, the winding/pressing portion 90 includes an extending portion 91 extending in the third direction Z1 from the end surface in the third direction Z1 of the first peripheral wall 40, a folded portion 92 provided on an end part of the extending portion 91 and a pressing portion 93 extending from an end part of the folded portion 92 toward the second peripheral wall 50.

The extending portion 91 is formed to be continuous and integral with the first peripheral wall 40. The folded portion 92 is formed to be continuous and integral with the extending portion 91. The folded portion 92 is formed to be folded toward the second peripheral wall 50 from an end part in the third direction Z1 of the extending portion 91. The folded portion 92 is, for example, folded in the third opposite direction Z2 into a U shape from the end part of the extending portion 91. The pressing portion 93 is formed to be continuous and integral with the folded portion 92. The pressing portion 93 extends in the third opposite direction Z2 from the folded portion 92 toward the projecting portion 80 and the second peripheral wall 50. The winding/pressing portion 90 is folded into a U shape convex in a direction separating from the first and second peripheral walls 40, 50 (here, the third direction Z1) by the extending portion 91, the folded portion 92 and the pressing portion 93.

The pressing portion 93 is provided to press the outer surface of the second peripheral wall 50 from outside. The pressing portion 93 is, for example, provided to press the outer surface of the projecting base portion 81 from outside. The pressing portion 93 has a facing surface 94 facing the outer surface of the second peripheral wall 50. The facing surface 94 extends, for example, in parallel to the outer surface of the second peripheral wall 50. The facing surface 94 is, for example, in surface contact with the outer surface of the second peripheral wall 50.

Here, a first projection amount P1 of the winding/pressing portion 90 from the end surface in the third direction Z1 of the first peripheral wall 40 is, for example, equal to a second projection amount P2 of the coupling portion 70 from the end surface in the third opposite direction Z2 of the first peripheral wall 40. The first projection amount P1 is a longest distance along the Z-axis direction from the end surface in the third direction Z1 of the first peripheral wall 40 to the projecting tip of the winding/pressing portion 90. The second projection amount P2 is a longest distance along the Z-axis direction from the end surface in the third opposite direction Z2 of the first peripheral wall 40 to the projecting tip of the coupling portion 70. A length of the folded portion 92 along the Y-axis direction is, for example, larger than that of the folded portion 73 along the Y-axis direction by a thickness of the second peripheral wall 50.

A projection amount of the winding/pressing portion 90 along the Y-axis direction from the outer surface of the second peripheral wall 50 is, for example, equal to a projection amount of the convex portion 55 along the Y-axis direction from the outer surface of the second peripheral wall 50. In other words, the convex portion 55 is so formed that the projection amount from the outer surface of the second peripheral wall 50 is equal to that of the winding/pressing portion 90.

As shown in FIG. 4, the winding/pressing portion 90 includes a through hole 95, into which the projection 82 is fit. The through hole 95 penetrates through the winding/pressing portion 90 in a thickness direction. The through hole 95 extends, for example, from an intermediate position of the folded portion 92 to an intermediate position of the pressing portion 93. The through hole 95 is formed in a size fittable to the projection 82.

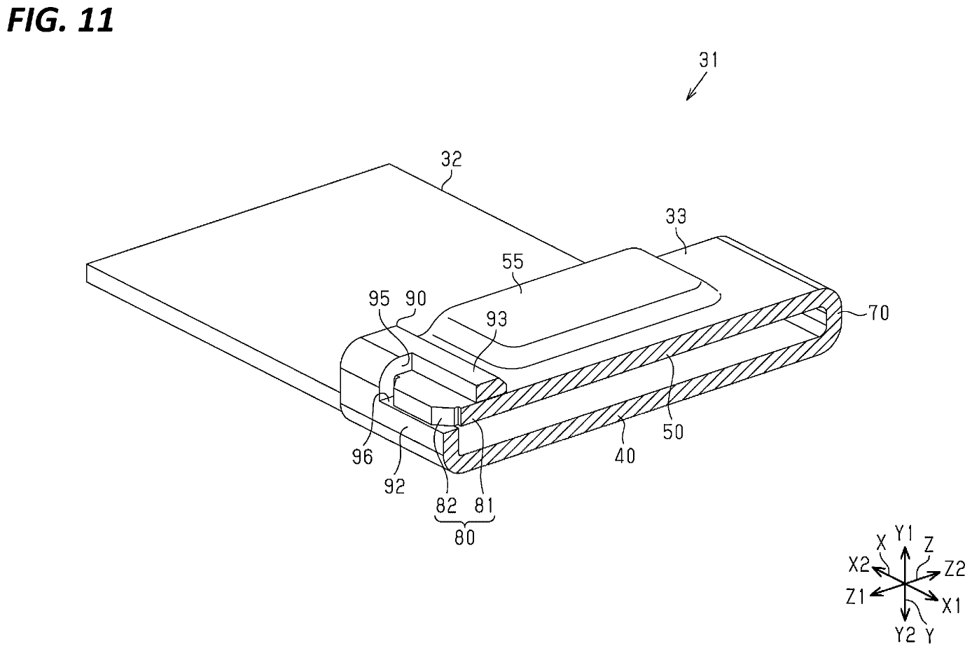

As shown in FIG. 11, the winding/pressing portion 90 has an engagement surface 96 constituting the through hole 95 and to be engaged with the projection 82. The engagement surface 96 is, for example, facing in the second direction Y1. The engagement surface 96 is facing the inner surface of the projection 82 in the Y-axis direction. The engagement surface 96 extends, for example, in parallel to the inner surface of the projection 82. The engagement surface 96 is, for example, in surface contact with the inner surface of the projection 82. The outer surface of the projection 82 is, for example, exposed from the winding/pressing portion 90 through the through hole 95.

In the terminal connecting portion 33 of this embodiment, the outer surface of the second peripheral wall 50 is pressed from outside by the pressing portion 93 of the winding/pressing portion 90, and the engagement surface 96 of the winding/pressing portion 90 is pressed from outside by the projection 82 of the projecting portion 80. In this way, an increase in separation distance between the first and second peripheral walls 40, 50 can be stably limited.

### Configuration of Protecting Portion 100

As shown in FIG. 4, the protecting portion 100 is, for example, provided to protect an end part in the first direction X1 of the terminal connecting portion 33. The protecting portion 100 is provided on the end part in the first direction X1 of the first peripheral wall 40. The protecting portion 100 is, for example, integrally formed to the first peripheral wall 40. The protecting portion 100 is formed to be folded from the end part in the first direction X1 of the first peripheral wall 40 while arranging the end part in the first direction X1 of the second peripheral wall 50 inside.

The protecting portion 100 includes an extending portion 101 extending in the second direction Y1 from the end part in the first direction X1 of the first peripheral wall 40 and a protection wall 102 extending toward the second peripheral wall 50 from an end part in the second direction Y1 of the extending portion 101. The extending portion 101 is formed to be continuous and integral with the first peripheral wall 40. The protection wall 102 is formed to be continuous and integral with the extending portion 101. The protecting portion 100 is folded into a U shape convex in a direction separating from the second peripheral wall 50 (here, in the first direction X1) by the extending portion 101 and the protection wall 102. The protection wall 102 is provided to face the end part in the first direction X1 of the second peripheral wall 50 in the Y-axis direction. The protection wall 102 is provided away from the outer surface of the second peripheral wall 50. That is, a gap is provided between the protection wall 102 and the outer surface of the second peripheral wall 50. The protection wall 102 is, for example, provided away from the outer surface of the second peripheral wall 50 with the columnar connecting portion 201 inserted in the tubular connecting portion 60. Note that a length of the extending portion 101 along the Y-axis direction is larger than that of the folded portion 92 along the Y-axis direction.

### Configuration of Housing Body 110

As shown in FIG. 3, the housing body 110 holds the female terminals 31 such that the wires 20 are drawn out in the first opposite direction X2. The housing body 110 accommodates the two female terminals 31 inside. The housing body 110 is, for example, formed into a box shape as a whole. The housing body 110 is, for example, made of synthetic resin.

The housing body 110 includes an opening 111 open in the first opposite direction X2. The wire 20 connected to the female terminal 31 is pulled out to the outside of the housing body 110 through the opening 111. The housing body 110 includes, for example, a peripheral wall 112 provided in the third opposite direction Z2 and a tube portion 113 provided on the outer surface of the peripheral wall 112. The tube portion 113 is a fitting tube portion, to which a mating housing of the unillustrated mating connector is fit. The tube portion 113 is provided on an end part in the first direction X1 of the peripheral wall 112. The tube portion 113 projects radially outwardly of the housing body 110 (here, in the third opposite direction Z2) from the outer surface of the peripheral wall 112. The tube portion 113 is, for example, formed into a rectangular tube shape.

The tube portion 113 includes an insertion hole 114. The insertion hole 114 is formed to allow communication between the inside and outside of the housing body 110. The insertion hole 114 is open in the third direction Z1 and also in the third opposite direction Z2. For example, the insertion hole 114 penetrates through the tube portion 113 in the Z-axis direction and penetrates through the peripheral wall 112 in the Z-axis direction. The insertion hole 114 is formed to expose the female terminals 31 accommodated in the housing body 110. Here, each female terminal 31 accommodated inside the housing body 110 is so provided that an opening end of the tubular connecting portion 60 is exposed through the insertion hole 114.

### Configuration of Retainer 120

The retainer 120 is mounted into the tube portion 113 of the housing body 110. The retainer 120 includes a body portion 121 and one or more (two in this embodiment) restricting portions 122 for restricting movements of the female terminals 31 in the first opposite direction X2. The retainer 120 is, for example, a single component in which the body portion 121 and the restricting portions 122 are continuously and integrally formed. The retainer 120 is, for example, made of synthetic resin.

The body portion 121 is, for example, formed into a frame shape as a whole. The outer peripheral edge of the body portion 121 is, for example, formed to have a rectangular planar shape when viewed from the Z-axis direction. The body portion 121 is, for example, formed to cover an end surface in the third opposite direction Z2 of the tube portion 113.

The body portion 121 includes one or more (two in this embodiment) insertion holes 123. Each insertion hole 123 penetrates through the body portion 121 in the Z-axis direction. Each insertion hole 123 is formed to communicate with the insertion hole 114 of the tube portion 113. The two insertion holes 123 are, for example, formed to expose the respective opening ends of the tubular connecting portions 60 of the two female terminals 31 accommodated in the housing body 110.

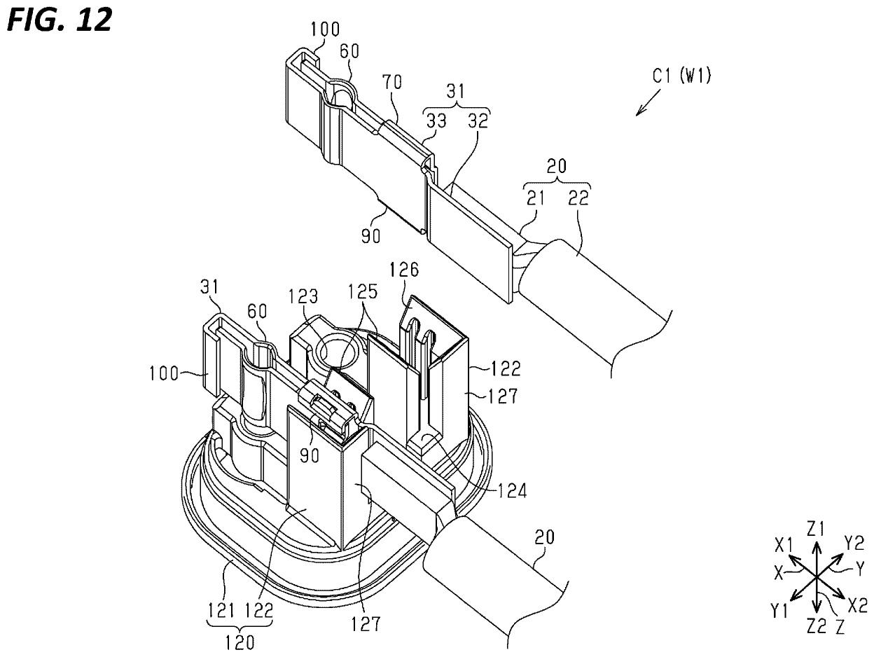

As shown in FIG. 12, the two restricting portions 122 are respectively provided to correspond to the two female terminals 31. The two restricting portions 122 are, for example, provided side by side along the Y-axis direction. Each restricting portion 122 is, for example, in the form of a tube for accommodating a part of the female terminal 31. Each restricting portion 122 is formed to have a U-shaped transverse cross-sectional shape as a whole. An axial direction of each restricting portion 122 extends along the X-axis direction. Each restricting portion 122 is open in the first direction X1 and also in the first opposite direction X2. Each restricting portion 122 is open in the third direction Z1.

Each female terminal 31 is, for example, inserted into an internal space of each restricting portion 122 along the third opposite direction Z2. An end part in the first opposite direction X2 of the terminal connecting portion 33 in each female terminal 31 is, for example, accommodated into the internal space of each restricting portion 122. The two female terminals 31 are, for example, respectively accommodated in the two restricting portions 122 in orientations different from each other. In particular, the female terminal 31 is accommodated in the restricting portion 122 provided on the second direction Y1 side, out of the two restricting portions 122, in such a posture that the winding/pressing portion 90 is facing in the third direction Z1. The female terminal 31 is accommodated in the restricting portion 122 provided on the second opposite direction Y2 side, out of the two restricting portions 122, in such a posture that the winding/pressing portion 90 is facing in the third opposite direction Z2. Specifically, the female terminal 31 provided on the second opposite direction Y2 side is accommodated in the restricting portion 122 in a posture rotated from the female terminal 31 on the second direction Y1 side by 180°. As shown in FIG. 3, each restricting portion 122 is inserted into the housing body 110 along the third direction Z1 when the retainer 120 is mounted into the tube portion 113 of the housing body 110. At this time, each restricting portion 122 is so inserted into the housing body 110 that the female terminal 31 is accommodated thereinto.

As shown in FIGS. 12, 13 and 14, each restricting portion 122 includes a bottom wall 124, a side wall 125 projecting from a first side edge of the bottom wall 124 and a side wall 126 projecting from a second side edge of the bottom wall 124. The first side edge of the bottom wall 124 is facing the bottom wall 124 of the other restricting portion 122. The second side edge of the bottom wall 124 is provided on a side opposite to the first side edge in the Y-axis direction. The internal space of each restricting portion 122 is formed by a space surrounded by the bottom wall 124, the side wall 125 and the side wall 126.

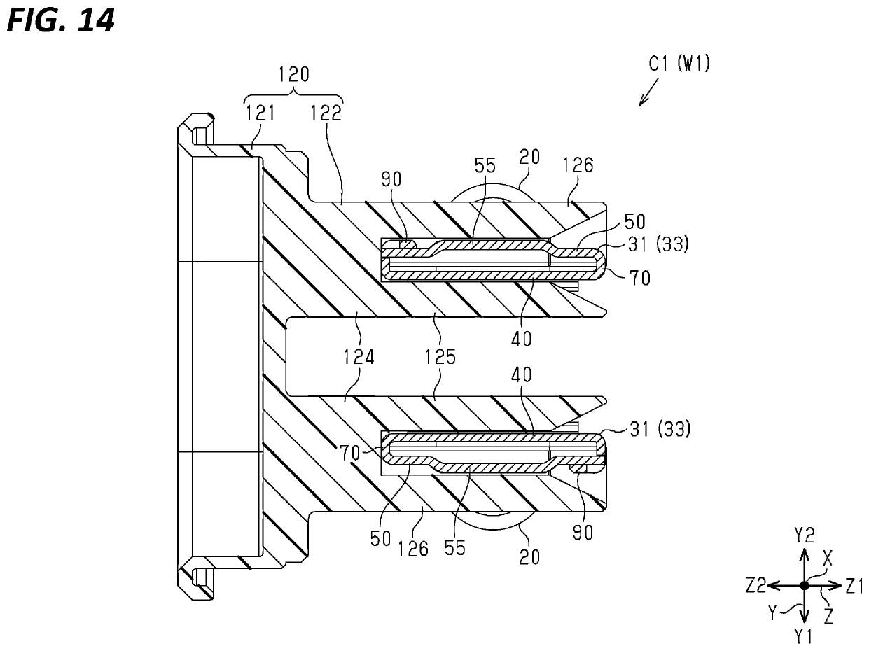

As shown in FIG. 14, each side wall 125, 126 is formed to be continuous and integral with the bottom wall 124. Each side wall 125, 126 projects in the third direction Z1 from the bottom wall 124. Each side wall 125, 126 is, for example, in the form of a plate. The two side walls 125, 126 are, for example, facing each other in a width direction of the bottom wall 124 (here, the Y-axis direction).

An interval between the inner surface of the side wall 125 and that of the side wall 126 is, for example, set to be able to accommodate the winding/pressing portion 90. A shortest distance between the inner surface of the side wall 125 and that of the side wall 126 is set to be slightly larger than a longest distance of the winding/pressing portion 90 along the Y-axis direction. Here, the convex portion 55 of the female terminal 31 is so formed that the projection amount along the Y-axis direction from the outer surface of the second peripheral wall 50 is equal to the projection amount along the Y-axis direction of the winding/pressing portion 90. Thus, the convex portion 55 can be suitably accommodated between the inner surface of the side wall 125 and that of the side wall 126. By providing such a convex portion 55, gaps between the female terminal 31 and the inner surfaces of the side walls 125, 126 can be suppressed from becoming larger in a part where the winding/pressing portion 90 is not provided. In this way, the inclination of the female terminal 31 inside each restricting portion 122 can be suitably suppressed.

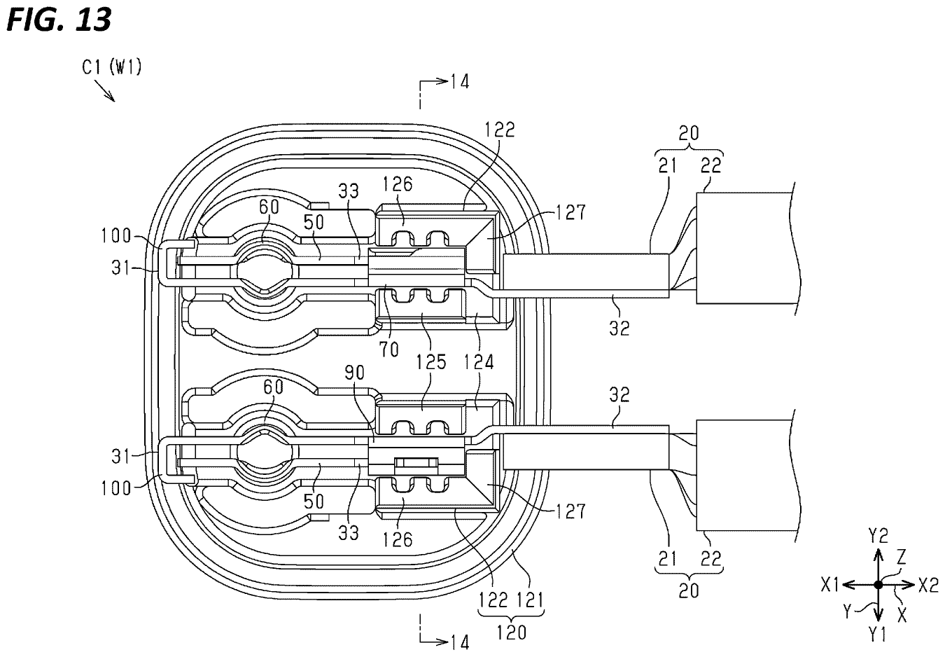

As shown in FIG. 13, each restricting portion 122 includes an engagement wall 127 to be engaged with the female terminal 31. The engagement wall 127 is, for example, provided to close a part of an opening in the first opposite direction X2 of the restricting portion 122. The engagement wall 127 is, for example, formed to be continuous and integral with the bottom wall 124. The engagement wall 127 is, for example, formed to be continuous and integral with the side wall 126. The engagement wall 127 extends, for example, toward the side wall 125 along the Y-axis direction from an end part in the first opposite direction X2 of the side wall 126. The engagement wall 127 extends up to the side wall 125 in the Y-axis direction.

The engagement wall 127 is provided to be engageable with the end surface in the first opposite direction X2 of the second peripheral wall 50 of the female terminal 31 in the X-axis direction when the retainer 120 is mounted into the housing body 110 (see FIG. 2). The engagement wall 127 restricts a movement of the female terminal 31 in the first opposite direction X2. The restricting portion 122 including such an engagement wall 127 assures the position in the X-axis direction of the female terminal 31 inside the housing body 110 (see FIG. 2).

Next, functions and effects of this embodiment are described. (1-1) The female terminal 31 is provided with the first peripheral wall 40 having the first tubular portion 41, the second peripheral wall 50 having the second tubular portion 51 facing the first tubular portion 41 and the tubular connecting portion 60 composed of the first and second tubular portions 41, 51. The female terminal 31 is provided with the winding/pressing portion 90 for limiting the separation distance between the first inner surface 42 of the first tubular portion 41 and the second inner surface 52 of the second tubular portion 51. The tubular connecting portion 60 is a first connecting portion, into which the columnar connecting portion 201 of the male terminal 200 is inserted and which is electrically connected to the columnar connecting portion 201. The winding/pressing portion 90 is integrally formed to the first peripheral wall 40. The winding/pressing portion 90 is folded from the first peripheral wall 40 while embracing the end edge of the second peripheral wall 50 inside, and held in contact with the outer surface of the second peripheral wall 50.

According to this configuration, when the columnar connecting portion 201 of the male terminal 200 is press-fit into the tubular connecting portion 60 of the female terminal 31, an increase in separation distance between the first inner surface 42 of the first peripheral wall 40 and the second inner surface 52 of the second peripheral wall 50 is limited by the winding/pressing portion 90. By this limitation by the winding/pressing portion 90, the first and second inner surfaces 42, 52 are maintained in a state biased in directions approaching each other. Thus, the first and second inner surfaces 42, 52 can be suitably brought into contact with the outer peripheral surface of the columnar connecting portion 201. As a result, a press-contact state of the tubular connecting portion 60 and the columnar connecting portion 201 can be stably held. Further, the winding/pressing portion 90 is integrally formed to the first peripheral wall 40. Thus, the press-contact state of the tubular connecting portion 60 and the columnar connecting portion 201 can be held by a simple structure as compared to a conventional technique using a separate component such as a coil spring. That is, the structure of the female terminal 31 can be simplified as compared to the conventional technique using the separate component such as a coil spring.

(1-2) The first and second peripheral walls 40, 50 are coupled by the coupling portion 70 integrally formed to the both first and second peripheral walls 40, 50. In this way, the first and second peripheral walls 40, 50 can be integrally formed through the coupling portion 70. Thus, the female terminal 31 can be configured, such as by bending one metal plate. As a result, the structure of the female terminal 31 can be simplified.

(1-3) The winding/pressing portion 90 is provided on the side opposite to the coupling portion 70 across the first peripheral wall 40. Thus, the opening of the coupling portion 70, i.e. an increase in separation distance between the first and second peripheral walls 40, 50 can be suitably limited by the winding/pressing portion 90. As a result, an increase in separation distance between the first and second inner surfaces 42, 52 can be suitably limited by the winding/pressing portion 90.

(1-4) The first projection amount P1 of the winding/pressing portion 90 folded from the end surface in the third direction Z1 of the first peripheral wall 40 toward the second peripheral wall 50 is equal to the second projection amount P2 of the coupling portion 70 folded from the end surface in the third opposite direction Z2 of the first peripheral wall 40 toward the second peripheral wall 50. Thus, the winding/pressing portion 90 and the coupling portion 70 can be formed into nearly symmetrical shapes. In this way, the female terminal 31 can be accommodated even if the winding/pressing portion 90 is in a posture facing a first space capable of accommodating the winding/pressing portion 90, i.e. the internal space of the restricting portion 122 or the coupling portion 70 is in a posture facing the internal space. As a result, the limitation of an insertion direction of the female terminal 31 into the internal space of the restricting portion 122 can be mitigated. Therefore, the versatility of the female terminal 31 can be improved.

(1-5) The female terminal 31 is provided with the projection 82 projecting in the third direction Z1 from the end surface in the third direction Z1 of the second peripheral wall 50. The winding/pressing portion 90 includes the through hole 95 to be fit to the projection 82, and the engagement surface 96 constituting the through hole 95 and facing in the second direction Y1. The engagement surface 96 is engaged with the projection 82. According to this configuration, the outer surface of the second peripheral wall 50 is pressed from outside by the winding/pressing portion 90 and the projection 82 is engaged with the engagement surface 96, whereby the winding/pressing portion 90 is pressed by the projection 82. By these, an increase in separation distance between the first and second inner surfaces 42, 52 can be stably limited.

(1-6) The protection wall 102 of the protecting portion 100 integrally formed to the first peripheral wall 40 is provided to face the end part in the first direction X1 of the second peripheral wall 50 while being separated from this end part. Thus, the deformation of the second peripheral wall 50 can be suitably hindered by the protection wall 102, for example, even if an excessive external force is accidentally applied to the end part in the first direction X1 of the second peripheral wall 50 and the second peripheral wall 50 is deformed away from the first peripheral wall 40 due to that external force.

(1-7) The winding/pressing portion 90 is provided on the end part in the first opposite direction X2 of the first peripheral wall 40. The tubular connecting portion 60 is provided at the intermediate position between the winding/pressing portion 90 and the protecting portion 100 in the first direction X1. According to this configuration, the winding/pressing portion 90 is provided at a position different from the tubular connecting portion 60 in the first direction X1. An increase in separation distance between the first and second peripheral walls 40, 50 can be limited by such a winding/pressing portion 90. Consequently, an increase in separation distance between the first inner surface 42 constituting the tubular connecting portion 60 and the second inner surface 52 constituting the tubular connecting portion 60 can be limited by the winding/pressing portion 90.

(1-8) The wire connecting portion 32 to be electrically connected to the wire 20 is integrally formed to the first peripheral wall 40. Thus, the number of components of the female terminal 31 can be reduced and the structure of the female terminal 31 can be simplified.

(1-9) The tubular connecting portion 60 includes the plurality of linear contact portions 43 projecting radially inwardly of the tubular connecting portion 60 from the first inner surface 42 and provided away from each other in the circumferential direction of the tubular connecting portion 60. Each of the plurality of linear contact portions 43 extends along the axial direction of the tubular connecting portion 60. According to this configuration, when the columnar connecting portion 201 of the male terminal 200 is press-fit into the tubular connecting portion 60, the linear contact portions 43 provided on the first inner surface 42 constituting the tubular connecting portion 60 are pressed into line contact with the outer peripheral surface of the columnar connecting portion 201 at a plurality of positions separated in the circumferential direction. In this way, for example, even if a swinging movement is transmitted to the male terminal 200, a displacement of the male terminal 200 due to that swinging movement can be hindered by the contact of the male terminal 200 with the plurality of linear contact portions 43.

(1-10) The second inner surface 52 is formed to be arcuately recessed radially outwardly of the tubular connecting portion 60 in a cross-section. The tubular connecting portion 60 includes the protrusion 54 arcuately projecting radially inwardly of the tubular connecting portion 60 from the second inner surface 52 in a cross-section. According to this configuration, when the columnar connecting portion 201 of the male terminal 200 is press-fit into the tubular connecting portion 60, the protrusion 54 arcuately projecting radially inwardly from the second inner surface 52 constituting the tubular connecting portion 60 in a cross-section is pressed into contact with the outer peripheral surface of the columnar connecting portion 201. In this way, the protrusion 54 can be pressed into contact with the outer peripheral surface of the columnar connecting portion 201 with a high contact pressure, wherefore the press-contact state of the tubular connecting portion 60 and the columnar connecting portion 201 can be stably held.

### Second Embodiment

Hereinafter, a female terminal and a connector of a second embodiment are described. The connector of this embodiment is different from the first embodiment in the structure of the female terminal. The following description is made, centering on points of difference from the first embodiment. Note that the same components as those of the first embodiment or corresponding components are denoted by the same reference signs and some or all of those components may not be described.

### Configuration of Female Terminal 31a

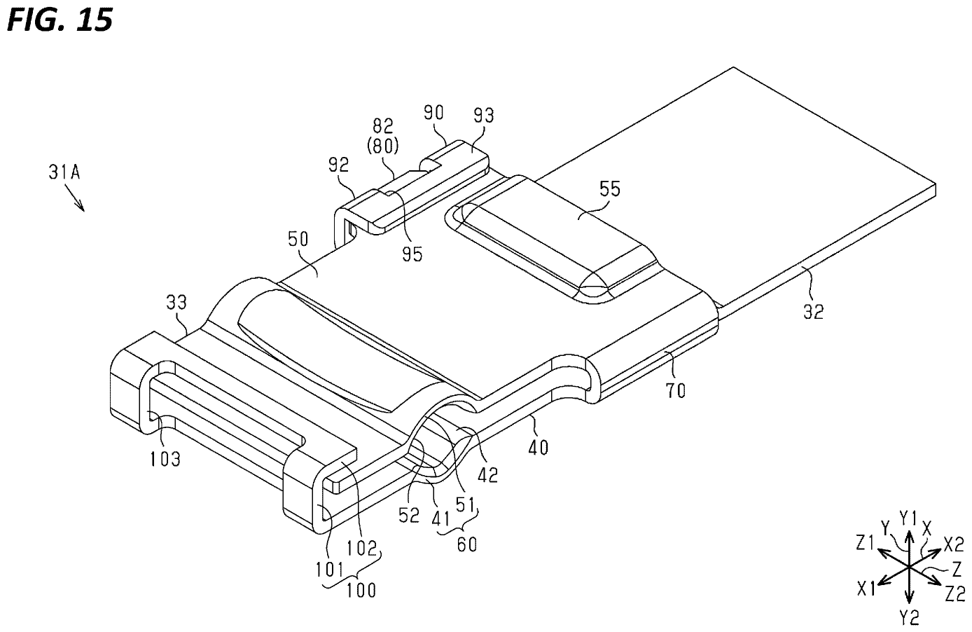

As shown in FIG. 15, a female terminal 31A includes a wire connecting portion 32 and a terminal connecting portion 33. The terminal connecting portion 33 includes a first peripheral wall 40 having a first tubular portion 41, a second peripheral wall 50 having a second tubular portion 51 and a tubular connecting portion 60 composed of the first and second tubular portions 41, 51. The terminal connecting portion 33 includes a coupling portion 70, a projecting portion 80, a winding/pressing portion 90 and a protecting portion 100.

The protecting portion 100 includes an extending portion 101 extending in the second direction Y1 from an end part in the first direction X1 of the first peripheral wall 40 and a protection wall 102 extending from an end part in the second direction Y1 of the extending portion 101 toward the second peripheral wall 50.

The protecting portion 100 includes an opening hole 103 penetrating through the extending portion 101 in the first direction X1 to expose an end surface in the first direction X1 of the second peripheral wall 50. The opening hole 103 is, for example, formed to expose an end edge in the second direction Y1 of the first peripheral wall 40 and an end edge in the second opposite direction Y2 of the second peripheral wall 50.

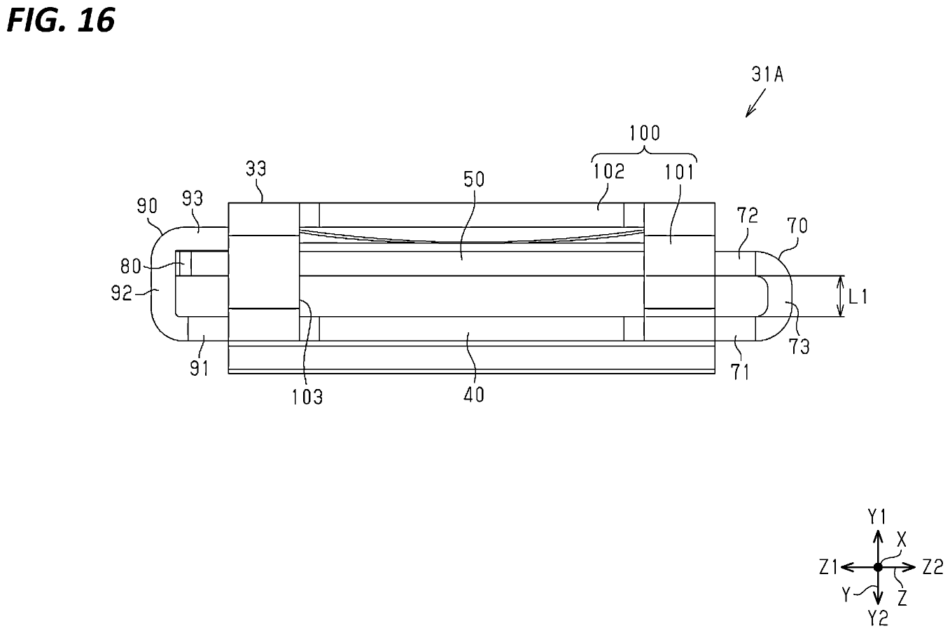

As shown in FIG. 16, the opening hole 103 exposes the first and second peripheral walls 40, 50 such that a distance Ll between the end edge in the second direction Y1 of the first peripheral wall 40 and the end edge in the second opposite direction Y2 of the second peripheral wall 50 can be measured from outside through the opening hole 103. That is, the opening hole 103 is an opening window for measuring the distance L1 from outside. Here, the distance L1 is equivalent to an interval between the inner surface of the first peripheral wall 40, i.e. an end surface in the second direction Y1 of the first peripheral wall 40, and the inner surface of the second peripheral wall 50, i.e. an end surface in the second opposite direction Y2 of the second peripheral wall 50. That is, the distance L1 is a gap between the first and second peripheral walls 40, 50.

As shown in FIG. 15, the opening hole 103 is, for example, provided at an intermediate position of the protecting portion 100 in the Z-axis direction. The opening hole 103 is, for example, formed to cut an intermediate part in the Z-axis direction of the protecting portion 100. The opening hole 103 is formed to penetrate through the extending portion 101 in a thickness direction (here, the X-axis direction). The opening hole 103 is open in both the first direction X1 and the first opposite direction X2. The opening hole 103 is, for example, formed to penetrate through the extending portion 101 in an extension direction (here, the Y-axis direction). The opening hole 103 is open in both the second direction Y1 and the second opposite direction Y2. The opening hole 103 extends, for example, up to an intermediate position of the protection wall 102 in the X-axis direction. For example, the opening hole 103 formed in the protection wall 102 is formed to overlap an end part in the first direction X1 of the second peripheral wall 50 in the Y-axis direction. In other words, the opening hole 103 is formed to expose the outer surface (i.e. an end surface in the second direction Y1) of the end part in the first direction X1 of the second peripheral wall 50. The opening hole 103 extends, for example, up to an intermediate position of the first peripheral wall 40 in the X-axis direction. In other words, the opening hole 103 is formed to cut the end part in the first direction X1 of the first peripheral wall 40. In this way, the end edge in the second direction Y1 of the first peripheral wall 40 can be suitably exposed through the opening hole 103. The opening hole 103 formed in the first peripheral wall 40 is, for example, formed to overlap the opening hole 103 formed in the protection wall 102.

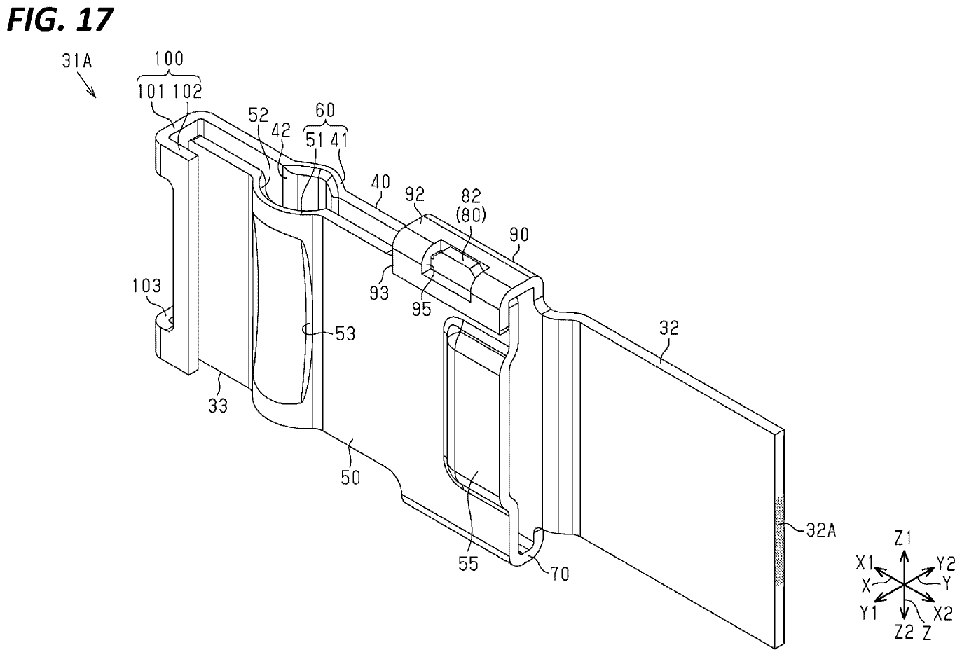

As shown in FIG. 17, a part of an end surface in the first opposite direction X2 of the wire connecting portion 32 is, for example, a cutting surface 32A. The cutting surface 32A is, for example, provided at an intermediate position of the wire connecting portion 32 in the Z-axis direction. The cutting surface 32A extends, for example, along the Z-axis direction. The cutting surface 32A has a surface roughness different from those of parts other than the cutting surface 32A, out of the end surface in the first opposite direction X2 of the wire connecting portion 32.

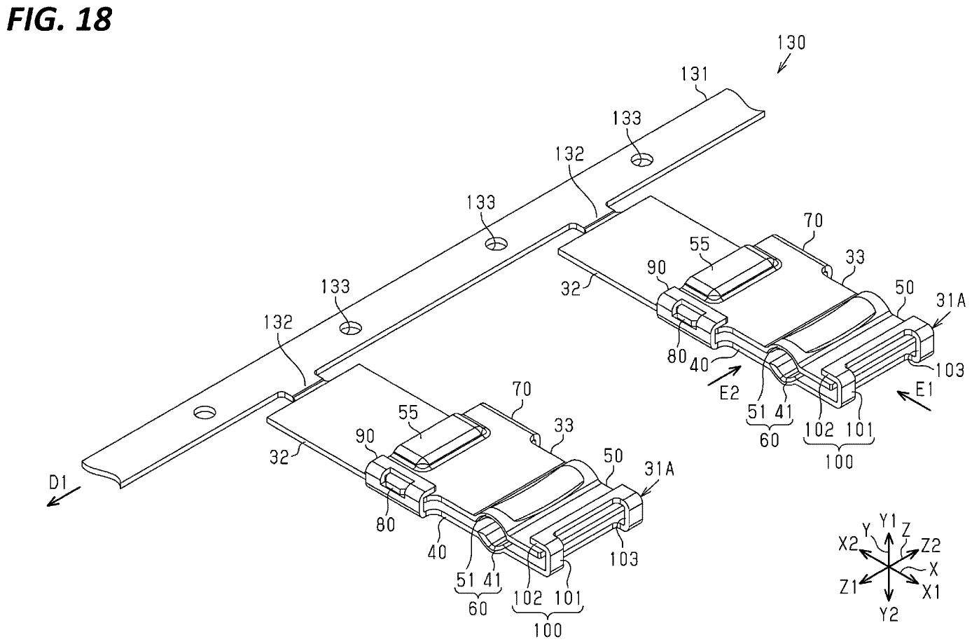

As shown in FIG. 18, a structure 130 in which a plurality of the female terminals 31A are coupled to each other by a strip-like carrier 131 is, for example, formed in a halfway step during the manufacturing of the female terminals 31A. The structure 130 is, for example, formed by press-working or bending a metal plate material. In the structure 130, the carrier 131 is connected to a part of an end surface in the first opposite direction X2 of the wire connecting portion 32 in each female terminal 31A. In particular, the carrier 131 includes a plurality of projecting coupling portions 132 projecting toward the female terminals 31A and through holes 133. Each projecting coupling portion 132 is coupled to the part of the end surface in the first opposite direction X2 of the wire connecting portion 32 in each female terminal 31A.

Each female terminal 31A is formed by finally cutting the projecting coupling portion 132 of the carrier 131. Thus, the part of the end surface in the first opposite direction X2 of the wire connecting portion 32 becomes the cutting surface 32A (see FIG. 17) exposed by cutting the projecting coupling portion 132 of the carrier 131. That is, the cutting surface 32A shown in FIG. 17 is a cut mark.

The structure 130 shown in FIG. 18 is, for example, taken up on an unillustrated reel. At this time, the through holes 133 provided in the carrier 131 are used in taking up the structure 130 on the reel. A reel feeding direction D1 when the structure 130 is taken up on the reel coincides, for example, with the third direction Z1.

Here, to measure a gap between the first and second peripheral walls 40, 50 in each female terminal 31A of the structure 130, a method for irradiating a laser to the female terminal 31A from an irradiation direction E2 is thought. However, in this case, the reel feeding direction D1 and the laser irradiation direction E2 are parallel to each other. Thus, it is difficult to install a measuring device, e.g. a laser light source and a light receiver. That is, when the structure 130 is taken up on the reel along the feeding direction D1, it is difficult to install the measuring device between two female terminals 31A adjacent in the feeding direction D1.

Accordingly, each female terminal 31A in the structure 130 is provided with the opening hole 103 open in the first direction X1 orthogonal to the reel feeding direction D1. In this way, a laser can be irradiated to the female terminal 31A, specifically the first and second peripheral walls 40, 50, through the opening hole 103 from an irradiation direction E1 orthogonal to the reel feeding direction D1. The irradiation direction E1 coincides, for example, with the first opposite direction X2. By such laser irradiation from the irradiation direction E1, the distance L1 (see FIG. 16) between the end edge in the second direction Y1 of the first peripheral wall 40 and the end edge in the second opposite direction Y2 of the second peripheral wall 50 can be measured. In this case, the measuring device, e.g. a laser light source and a light receiver, can be provided at a position separated from the opening hole 103 of the female terminal 31A in the first direction X1. Thus, the measuring device can be installed at a position separated from the female terminal 31A in a direction orthogonal to the reel feeding direction D1. Therefore, when the structure 130 is taken up on the reel along the feeding direction D1, the contact of the female terminals 31A with the measuring device can be suitably suppressed.

By measuring the distance L1 (see FIG. 16) between the end edge in the second direction Y1 of the first peripheral wall 40 and the end edge in the second opposite direction Y2 of the second peripheral wall 50, an inner diameter of the tubular connecting portion 60 can be, for example, calculated based on the distance L1. Thus, whether or not the inner diameter of the tubular connecting portion 60 in each female terminal 31A is a desired size can be inspected by inspecting whether or not the distance L1 is a desired distance. Such an inspection can be carried out by irradiating a laser to the female terminal 31A in a state coupled to the carrier 131. Thus, whether or not the inner diameter of the tubular connecting portion 60 in each female terminal 31A is the desired size can be easily inspected for all the female terminals 31A.

According to this embodiment described above, the following functions and effects can be achieved in addition to the functions and effects of (1-1) to (1-10) of the first embodiment.

(2-1) The opening hole 103 is provided which penetrates through the extending portion 101 of the protecting portion 100 in the first direction X1 and exposes the end edge in the second direction Y1 of the first peripheral wall 40 and the end edge in the second opposite direction Y2 of the second peripheral wall 50. In this way, a laser can be, for example, irradiated to the first and second peripheral walls 40, 50 through the opening hole 103. That is, the laser can be irradiated to the first and second peripheral walls 40, 50 of the female terminal 31A from the position separated from the end surface in the first direction X1 of the female terminal 31A in the first direction X1. By such laser irradiation, the distance L1 between the end edge in the second direction Y1 of the first peripheral wall 40 and the end edge in the second opposite direction Y2 of the second peripheral wall 50 can be measured.

(2-2) The opening hole 103 is formed to cut the end part in the first direction X1 of the first peripheral wall 40. According to this configuration, the end edge in the second direction Y1 of the first peripheral wall 40 can be suitably exposed to outside through the opening hole 103. In this way, a laser can be suitably irradiated to the first and second peripheral walls 40, 50 through the opening hole 103.

### Third Embodiment

Hereinafter, a female terminal and a connector of a third embodiment are described. The connector of this embodiment is different from the second embodiment in the structure of the female terminal. The following description is made, centering on points of difference from the second embodiment. Note that the same components as those of the second embodiment or corresponding components are denoted by the same reference signs and some or all of those components may not be described.

### Configuration of Female Terminal 31b

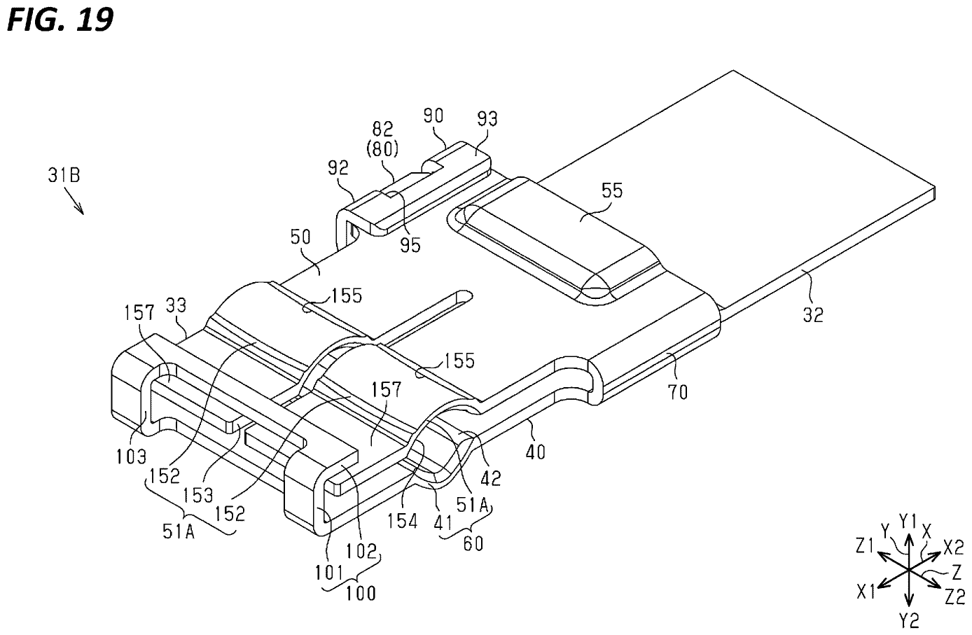

As shown in FIG. 19, a female terminal 31B includes a wire connecting portion 32 and a terminal connecting portion 33. The terminal connecting portion 33 includes a first peripheral wall 40 having a first tubular portion 41, a second peripheral wall 50 having a second tubular portion 51A and a tubular connecting portion 60 composed of the first and second tubular portions 41, 51A. The terminal connecting portion 33 includes a coupling portion 70, a projecting portion 80, a winding/pressing portion 90 and a protecting portion 100.

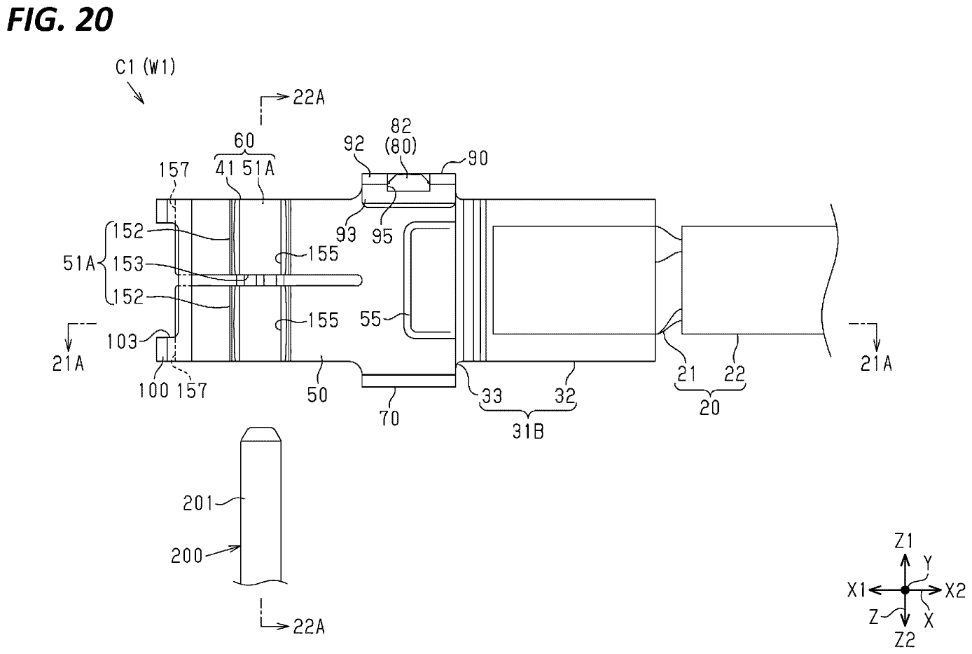

As shown in FIGS. 19 and 20, the second tubular portion 51A includes a plurality of (two in this embodiment) divided tubular portions 152 divided in an axial direction of the tubular connecting portion 60 (here, the Z-axis direction) and a slit 153 dividing the two divided tubular portions 152. The two divided tubular portions 152 are provided away from each other across the slit 153 in the axial direction of the tubular connecting portion 60. The two divided tubular portions 152 have, for example, the same structure.

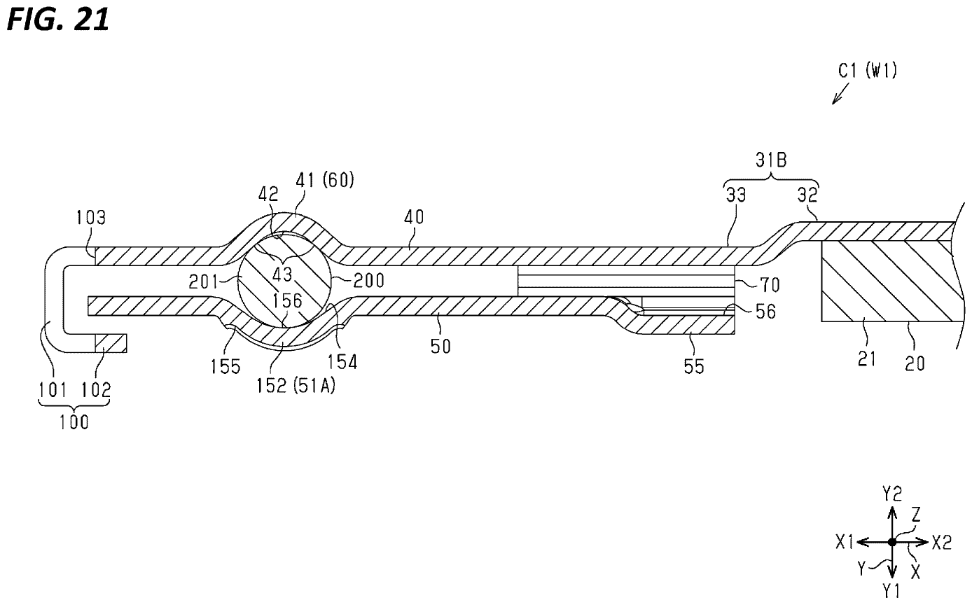

As shown in FIG. 21, each divided tubular portion 152 has a second inner surface 154 facing in the first opposite direction Y2 and an outer surface provided on a side opposite to the second inner surface 154. The outer surface of each divided tubular portion 152 is formed into a curved surface having an arcuate cross-sectional shape obtained by cutting the divided tubular portion 152 by a plane parallel to the X-axis direction. The outer surface of the divided tubular portion 152 arcuately projects radially outwardly of the tubular connecting portion 60 in a cross-section. Similarly, the second inner surface 154 of the divided tubular portion 152 is formed to be arcuately recessed radially outwardly of the tubular connecting portion 60 in a cross-section.

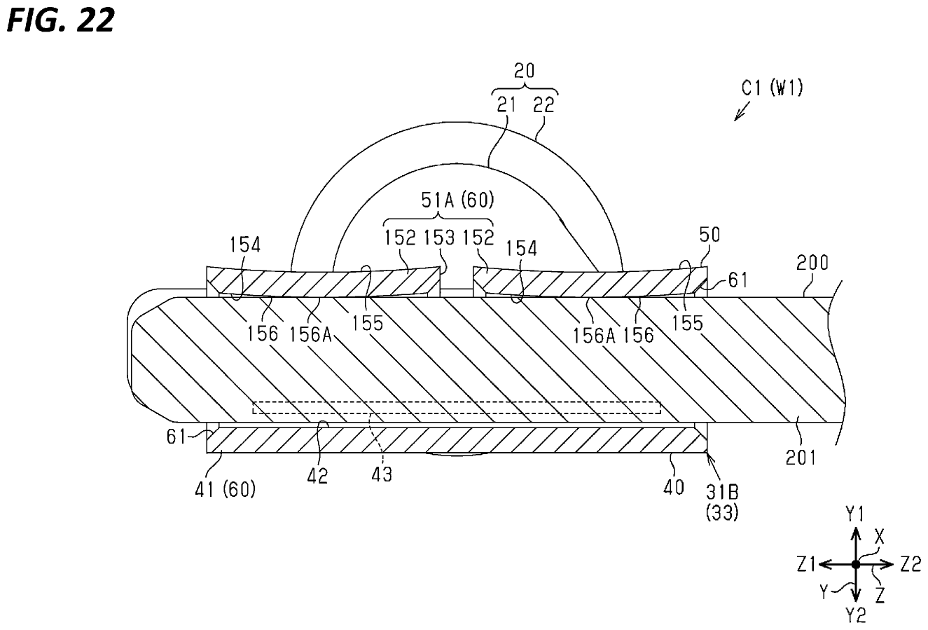

As shown in FIG. 22, the outer surface of each divided tubular portion 152 is provided with a dent portion 155 dented radially inwardly of the tubular connecting portion 60 from the outer surface. As shown in FIG. 20, the dent portion 155 is, for example, formed into a rectangular planar shape when viewed from the Y-axis direction. The dent portion 155 is, for example, formed over the entire length in the Z-axis direction of the divided tubular portion 152.

As shown in FIG. 22, the second inner surface 154 of each divided tubular portion 152 is provided with a protrusion 156 projecting radially inwardly of the tubular connecting portion 60 from the second inner surface 154. The protrusion 156 is, for example, provided on the second inner surface 154 of the divided tubular portion 152 in a part where the dent portion 155 is formed. The protrusion 156 can be, for example, formed by embossing. The protrusion 156 is formed into an embossed shape by pressurizing the outer surface of the divided tubular portion 152 by a die.

The protrusion 156 is, for example, formed such that a cross-sectional shape obtained by cutting the protrusion 156 by a plane parallel to the axial direction of the tubular connecting portion 60 (here, the Z-axis direction) is a shape arcuately projecting radially inwardly of the tubular connecting portion 60. The protrusion 156 arcuately projects radially inwardly of the tubular connecting portion 60 from the second inner surface 154 in a cross-section. The protrusion 156 extends along a circumferential direction of the tubular connecting portion 60. The protrusion 156 extends along the axial direction of the tubular connecting portion 60. A projecting tip 156A of the protrusion 156 is, for example, brought into point contact with the outer peripheral surface of a columnar connecting portion 201 of a male terminal 200.

Each projecting tip 156A is, for example, provided at a center in the axial direction of the divided tubular portion 152 (here, the Z-axis direction). Each projecting tip 156A is provided at a position separated from a center of the tubular connecting portion 60 in the axial direction by a predetermined distance in the axial direction of the tubular connecting portion 60.

As shown in FIG. 19, the slit 153 penetrates through the second tubular portion 51A in the Y-axis direction. The slit 153 is, for example, provided at a center position of the tubular connecting portion 60 in the axial direction of the tubular connecting portion 60.

The slit 153 extends over the entire circumferential length of the second tubular portion 51A along the circumferential direction of the second tubular portion 51A. The slit 153 extends, for example, from an end surface in the first direction X1 of the second peripheral wall 50 to a position further in the first opposite direction X2 than the divided tubular portions 152 along the first opposite direction X2. The slit 153 is open in the first direction X1. That is, the slit 153 is formed to be cut in the first opposite direction X2 from the end surface in the first direction X1 of the peripheral wall 150.

The end part in the first direction X1 of the second peripheral wall 50 has a forked structure divided by the slit 153. That is, the end part in the first direction X1 of the second peripheral wall 50 includes two divided portions 157 by being forked. Each divided portion 157 includes the divided tubular portion 152. Each divided portion 157 is, for example, formed to be supported in a cantilever manner on the end part in the first opposite direction X2 of the second peripheral wall 50. The two divided portions 157 have, for example, the same structure. The two divided portions 157 are plane-symmetrically formed with respect to a virtual plane including a center of the slit 153 in the Z-axis direction and extending in the X-axis direction.

The protecting portion 100 includes an extending portion 101 extending in the second direction Y1 from an end part in the first direction X1 of the first peripheral wall 40 and a protection wall 102 extending from an end part in the second direction Y1 of the extending portion 101 toward the second peripheral wall 50.

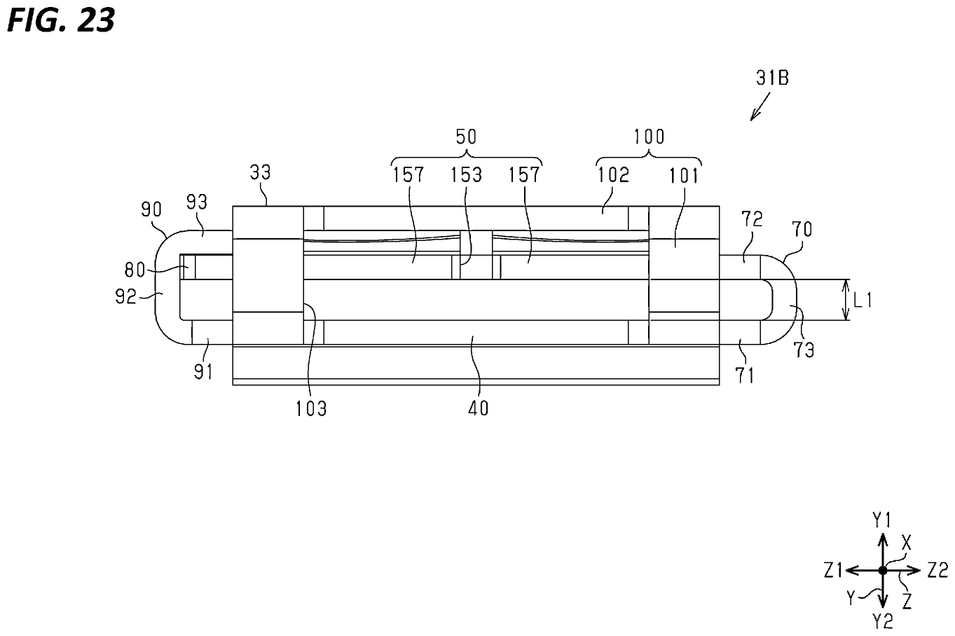

As shown in FIG. 23, the protecting portion 100 includes an opening hole 103. The opening hole 103 is, for example, formed to expose an end edge in the second direction Y1 of the first peripheral wall 40 and an end edge in the second opposite direction Y2 of the second peripheral wall 50. The opening hole 103 is formed to expose the end edge in the second opposite direction Y2 of the second peripheral wall 50 in each of the plurality of divided portions 157. In this way, a distance L1 between the end edge in the second opposite direction Y2 of the second peripheral wall 50 in each of the plurality of divided portions 157 and the end edge in the second direction Y1 of the first peripheral wall 40 can be measured from outside through the opening hole 103.

According to the embodiment described above, the following functions and effects can be achieved in addition to the functions and effects of (1-1) to (1-10) of the first embodiment and those of (2-1) and (2-2) of the second embodiment.

(3-1) The second tubular portion 51A includes the plurality of divided tubular portions 152 divided in the axial direction of the tubular connecting portion 60. Each of the plurality of divided tubular portions 152 includes the second inner surface 154 and the protrusion 156 arcuately projecting radially inwardly of the tubular connecting portion 60 from the second inner surface 154 in a cross-section.

According to this configuration, when the columnar connecting portion 201 of the male terminal 200 is press-fit into the tubular connecting portion 60, the protrusion 156 provided on the second inner surface 154 of each of the plurality of divided tubular portions 152 is pressed into contact with the outer peripheral surface of the columnar connecting portion 201. Thus, in the tubular connecting portion 60, the plurality of protrusions 156 are pressed into contact with the outer peripheral surface of the columnar connecting portion 201 at a plurality of positions separated in the axial direction. In this way, even if a swinging movement is, for example, transmitted to the male terminal 200, a displacement of the male terminal 200 due to that swinging movement can be suitably hindered by the contact of the plurality of protrusions 156 with the columnar connecting portion 201. That is, as compared to the case where only one protrusion 156 is provided on the second inner surface 154 of the tubular portion 151, the displacement of the columnar connecting portion 201 inside the tubular connecting portion 60 can be suppressed by contact pressures by the plurality of protrusions 156.

(3-2) The slit 153 dividing the two divided tubular portions 152 is provided at the center position of the tubular connecting portion 60 in the axial direction. At this time, when the columnar connecting portion 201 of the male terminal 200 inserted into the tubular connecting portion 60 is displaced, the columnar connecting portion 201 rotates with the center of the tubular connecting portion 60 in the axial direction as a center of rotation. If a contact part of the protrusion 156 and the columnar connecting portion 201 is provided at such a center of rotation, a contact pressure with the columnar connecting portion 201 by the protrusion 156 cannot be exerted as a force for suppressing a displacement of the columnar connecting portion 201. In contrast, in the female terminal 31B of this embodiment, the protrusions 156 are provided at positions different from the slit 53 provided at the center of the tubular connecting portion 60 in the axial direction. Thus, the protrusions 156 and the columnar connecting portion 201 can be brought into contact at the positions different from the center of rotation in the displacement of the columnar connecting portion 201. In this way, contact pressures with the columnar connecting portion 201 by the protrusions 156 can be suitably exerted as a force for suppressing the displacement of the columnar connecting portion 201. As a result, the displacement of the columnar connecting portion 201 inside the tubular connecting portion 60 can be suitably suppressed by the contact pressures by the plurality of protrusions 156.

(3-3) The opening hole 103 is formed to expose the end edge in the second opposite direction Y2 of the second peripheral wall 50 in each of the plurality of divided portions 157. Thus, the distance L1 between the end edge in the second opposite direction Y2 of the second peripheral wall 50 in each of the plurality of divided portions 157 and the end edge in the second direction Y1 of the first peripheral wall 40 can be measured by irradiating a laser to the first and second peripheral walls 40, 50 through the opening hole 103.

### Other Embodiments

The above respective embodiments can be modified and carried out as follows. The above respective embodiments and the following modifications can be combined with each other and carried out without technically contradicting.
The structure of the female terminal 31, 31A, 31B in each of the above embodiments can be changed as appropriate.
The convex portion 55 of the female terminal 31, 31A, 31B may be omitted. In this case, the concave portion 56 of the female terminal 31, 31A, 31B is also omitted.
Although the protecting portion 100 is integrally formed to the first peripheral wall 40 in the above respective embodiments, there is no limitation to this. For example, the protecting portion 100 may be integrally formed to the second peripheral wall 50. The protecting portion 100 in this case is, for example, formed to be folded from the end part in the first direction X1 of the second peripheral wall 50 while arranging the end part in the first direction X1 of the first peripheral wall 40 inside.
The protecting portion 100 of the female terminal 31 in the first embodiment may be omitted.
The guiding portions 61 in the tubular connecting portion 60 of the female terminal 31, 31A, 31B may be omitted.
Three or more linear contact portions 43 may be provided on the first inner surface 42 of the first tubular portion 41 of the female terminal 31, 31A, 31B.
The plurality of linear contact portions 43 and the protrusion 54 having an arcuate cross-section may be provided on the first inner surface 42 of the female terminal 31, 31A, 31B.
The structure of the opening hole 103 in the female terminal 31A, 31B may be changed as appropriate. For example, a length along the Z-axis direction of the opening hole 103 may be changed as appropriate.
Although the plurality of linear contact portions 43 are provided on the first inner surface 42 of the first tubular portion 41 and the protrusion 54 having an arcuate cross-section is provided on the second inner surface 52 of the second tubular portion 51 in the female terminal 31 of the first embodiment, there is no limitation to this. For example, the protrusion 54 having an arcuate cross-section may be provided on the first inner surface 42 and the plurality of linear contact portions 43 may be provided on the second inner surface 52. For example, linear contact portions 43 may be provided on the both first and second inner surfaces 42, 52. For example, protrusions 54 having an arcuate cross-section may be provided on the both first and second inner surfaces 42, 52. Note that similar changes can be made also for the female terminal 31A in the second embodiment.
Although the plurality of linear contact portions 43 are provided on the first inner surface 42 of the first tubular portion 41 and the second tubular portion 51A includes the plurality of divided tubular portions 152 and the protrusions 156 provided on the second inner surfaces 154 of the divided tubular portions 52 in the female terminal 31B of the third embodiment, there is no limitation to this. For example, the second tubular portion 51A may include the plurality of linear contact portions 43 and the first tubular portion 41 may include the plurality of divided tubular portions 152 and the protrusions 156 provided on the second inner surfaces 154 of the divided tubular portions 152.
The number of the divided tubular portions 152 of the second tubular portion 51A in the third embodiment is not particularly limited. For example, the second tubular portion 51A may include three or more divided tubular portions 152.
The structure of the slit 153 of the third embodiment can be changed as appropriate.
The position of the winding/pressing portion 90 in the female terminal 31, 31A, 31B may be changed as appropriate. For example, the winding/pressing portion 90 may be provided at a position different from the coupling portion 70 in the X-axis direction.
Although the wire connecting portion 32 is integrally formed to the first peripheral wall 40 in each of the above embodiments, there is no limitation to this. For example, the wire connecting portion 32 may be integrally formed to the second peripheral wall 50.
In the female terminal 31, 31A, 31B of each of the above embodiments, only the terminal connecting portion 33, out of the wire connecting portion 32 and the terminal connecting portion 33, is structured by folding the peripheral wall 50 into two on the peripheral wall 40. Without limitation to this, for example, both the wire connecting portion 32 and the terminal connecting portion 33 may be structured by folding two plate materials.
The structure of the housing body 110 in each of the above embodiments can be changed as appropriate. For example, if the housing body 110 is structured to be able to accommodate the female terminal 31, the other structure can be changed as appropriate.
The structure of the retainer 120 in each of the above embodiments can be changed as appropriate. For example, the restricting portions 122 may be omitted.
Although the columnar connecting portion 201 of the male terminal 200 is embodied to have a cylindrical shape in each of the above embodiments, there is no limitation to this. For example, the columnar connecting portion 201 may be formed into a columnar shape other than the cylindrical shape. For example, a transverse cross-sectional shape of the columnar connecting portion 201 may be formed into an elliptical shape or a polygonal shape.
As shown in FIGS. 4, 6, 11, 15 and 17, the winding/pressing portion 90 of the female terminal 31 according to the non-limiting embodiment may include the plate-like pressing portion 93. This plate-like pressing portion 93 may have a pressing surface (XZ surface) for pressing the outer surface of the second peripheral wall 50 near the convex portion 55 of the female terminal 31. This plate-like pressing portion 93 may have a tip edge adjacent to or oriented toward the convex portion 55 of the female terminal 31.
As shown in FIGS. 9, 11 and 14, the convex portion 55 of the female terminal 31 according to the non-limiting embodiment can have an elongated top surface having a length (Z), a width (X) and a height (Y). This elongated top surface may be a flat surface (XZ surface). One convex portion 55 of the female terminal 31 can be sufficient.
The protecting portion 100 of the female terminal 13 according to the shown non-limiting embodiment may be referred to as a distal end of the female terminal 31. As shown in FIGS. 15 and 16, the opening hole 103 of the protecting portion 100 of the female terminal 31 may be referred to as a terminal inspection window for allowing the passage of a gap measurement laser irradiated toward the distal end of the female terminal 31 from the outside of the female terminal 31.
The embodiments disclosed this time should be considered illustrative in all aspects, rather than restrictive. The scope of the present invention is represented not by the above meaning, but by claims and is intended to include all changes in the scope of claims and in the meaning and scope of equivalents.

### LIST OF REFERENCE NUMERALS

20 . . . wire, 21 . . . core wire, 22 . . . insulation coating, 30 . . . housing, 31, 31A, 31B . . . female terminal, 32 . . . wire connecting portion (second connecting portion), 32A . . . cutting surface, 33 . . . terminal connecting portion, 40 . . . first peripheral wall, 41 . . . first tubular portion, 42 . . . first inner surface, 43 . . . linear contact portion, 50 . . . second peripheral wall, 51, 51A . . . second tubular portion, 52 . . . second inner surface, 53 . . . dent portion, 54 . . . protrusion, 55 . . . convex portion, 56 . . . concave portion, 60 . . . tubular connecting portion (first connecting portion), 61 . . . guiding portion, 70 . . . coupling portion, 71, 72 . . . extending portion, 73 . . . folded portion, 80 . . . projecting portion, 81 . . . projecting base portion, 82 . . . projection, 90 . . . winding/pressing portion, 91 . . . extending portion, 92 . . . folded portion, 93 . . . pressing portion, 94 . . . facing surface, 95 . . . through hole, 96 . . . engagement surface, 100 . . . protecting portion, 101 . . . extending portion, 102 . . . protection wall, 103 . . . opening hole, 110 . . . housing body, 111 . . . opening, 112 . . . peripheral wall, 113 . . . tube portion, 114 . . . insertion hole, 120 . . . retainer, 121 . . . body portion, 122 . . . restricting portion, 123 . . . insertion hole, 124 . . . bottom wall, 125, 126 . . . side wall, 127 . . . engagement wall, 130 . . . structure, 131 . . . carrier, 132 . . . projecting coupling portion, 133 . . . through hole, 152 . . . divided tubular portion, 153 . . . slit, 154 . . . second inner surface, 155 . . . dent portion, 156 . . . protrusion, 156A . . . projecting tip, 157 . . . divided portion, 200 . . . male terminal, 201 . . . columnar connecting portion, W1 . . . wiring harness, C1 . . . connector, E1 . . . irradiation direction, E2 . . . irradiation direction, L1 . . . distance, P1 . . . first projection amount, P2 . . . second projection amount, X1 . . . first direction, X2 . . . first opposite direction, Y1 . . . second direction, Y2 . . . second opposite direction, Z1 . . . third direction, Z2 . . . third opposite direction

1. A female terminal, comprising:
a first peripheral wall having a first tubular portion;
a second peripheral wall having a second tubular portion facing the first tubular portion;
a tubular connecting portion composed of the first tubular portion and the second tubular portion; and
a winding/pressing portion for limiting a separation distance between a first inner surface of the first tubular portion and a second inner surface of the second tubular portion,
the tubular connecting portion being a first connecting portion, a columnar connecting portion of a male terminal being inserted into the first connecting portion, the first connecting portion being electrically connected to the columnar connecting portion,
the winding/pressing portion being integrally formed to the first peripheral wall, and
the winding/pressing portion being folded from the first peripheral wall while embracing an end edge of the second peripheral wall inside, the winding/pressing portion being held in contact with an outer surface of the second peripheral wall.

2. The female terminal of claim 1, further comprising a coupling portion coupling the first peripheral wall and the second peripheral wall, wherein:
the coupling portion is integrally formed to the first peripheral wall and integrally formed to the second peripheral wall.

3. The female terminal of claim 2, wherein:
the first peripheral wall is formed into a strip shape extending along a first direction,
the second peripheral wall is formed into a strip shape extending along the first direction,
the first inner surface is a surface facing in a second direction intersecting the first direction,
the second inner surface is a surface facing in a second opposite direction opposite to the second direction,
the winding/pressing portion is folded toward the second peripheral wall from an end surface in a third direction intersecting both the first direction and the second direction, out of the first peripheral wall, and
the coupling portion is formed to extend in the second direction from an end surface in a third opposite direction opposite to the third direction, out of the first peripheral wall, toward an end surface in the third opposite direction, out of the second peripheral wall.

4. The female terminal of claim 3, wherein:
the winding/pressing portion projects further in the third direction than the end surface in the third direction of the first peripheral wall,
the coupling portion projects further in the third opposite direction than the end surface in the third opposite direction of the first peripheral wall, and
a first projection amount of the winding/pressing portion from the end surface in the third direction of the first peripheral wall is equal to a second projection amount of the coupling portion from the end surface in the third opposite direction of the first peripheral wall.

5. The female terminal of claim 3, further comprising a projection projecting in the third direction from an end surface in the third direction of the second peripheral wall, wherein:
the winding/pressing portion includes a through hole to be fit to the projection and an engagement surface constituting the through hole and facing in the second direction, and
the engagement surface is engaged with the projection.

6. The female terminal of claim 3, further comprising a protecting portion provided on an end part in the first direction of the first peripheral wall, wherein:
the protecting portion is integrally formed to the first peripheral wall,
the protecting portion is formed to be folded from the end part in the first direction of the first peripheral wall while arranging an end part in the first direction of the second peripheral wall inside,
the protecting portion includes a protection wall provided to face the end part in the first direction of the second peripheral wall in the second direction, and
the protection wall is provided away from the end part in the first direction of the second peripheral wall.

7. The female terminal of claim 6, wherein:
the winding/pressing portion is provided on an end part in a first opposite direction opposite to the first direction, out of the first peripheral wall, and
the tubular connecting portion is provided at an intermediate position between the winding/pressing portion and the protecting portion in the first direction.

8. The female terminal of claim 6, wherein:
the second tubular portion is provided at an intermediate position of the second peripheral wall in the first direction,
the protecting portion includes an extending portion extending in the second direction from the end part in the first direction of the first peripheral wall, the protection wall extending in a first opposite direction opposite to the first direction from an end part in the second direction of the extending portion, and an opening hole penetrating through the extending portion in the first direction to expose an end surface in the first direction of the second peripheral wall, and
the opening hole is formed to expose an end edge in the second direction of the first peripheral wall and an end edge in the second opposite direction of the second peripheral wall.

9. The female terminal of claim 8, wherein:
the second tubular portion includes two divided tubular portions divided in an axial direction of the tubular connecting portion and a slit dividing the two divided tubular portions,
each of the plurality of divided tubular portions includes the second inner surface and a protrusion arcuately projecting radially inwardly of the tubular connecting portion from the second inner surface in a cross-section, and
the slit is provided at a center position of the tubular connecting portion in the axial direction.

10. The female terminal of claim 9, wherein:
the slit is formed to extend in the first opposite direction from the end surface in the first direction of the second peripheral wall,
the second peripheral wall includes two divided portions divided by the slit, and
the opening hole is formed to expose an end edge in the second opposite direction of the second peripheral wall in each of the two divided portions.

11. The female terminal of claim 6, further comprising a wire connecting portion provided on an end part in a first opposite direction opposite to the first direction, out of the first peripheral wall, wherein:
the wire connecting portion is a second connecting portion to be electrically connected to a wire,
the wire connecting portion is integrally formed to the first peripheral wall, and
the wire connecting portion extends in the first opposite direction from an end part in the first opposite direction of the first peripheral wall.

12. The female terminal of claim 1, wherein:
the tubular connecting portion includes a plurality of linear contact portions projecting radially inwardly of the tubular connecting portion from the first inner surface and provided away from each other in a circumferential direction of the tubular connecting portion, and
each of the plurality of linear contact portions extends along an axial direction of the tubular connecting portion.

13. The female terminal of claim 1, wherein:
the second inner surface is formed to be arcuately recessed radially outwardly of the tubular connecting portion in a cross-section, and
the tubular connecting portion includes a protrusion arcuately projecting radially inwardly of the tubular connecting portion from the second inner surface in a cross-section.

14. A connector, comprising:
the female terminal of claim 1; and
a housing for accommodating the female terminal inside.
